(19) United States
(12) Patent Application Publication
(10) Pub. No.: US 2005/0208235 A1
(43) Pub. Date: Sep. 22, 2005

(54) Image-receiving sheet for electrophotography and image-forming process

(75) Inventors: Ashita Murai, Shizuoka (JP); Yoshio Tani, Shizuoka (JP); Hiroshi Kajimaru, Kyoto (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: FUJI PHOTO FILM CO., LTD., Minami-Ashigara-shi (JP)

(21) Appl. No.: 11/079,464

(22) Filed: Mar. 15, 2005

(30) Foreign Application Priority Data
Mar. 16, 2004 (JP) 2004-075180
Aug. 26, 2004 (JP) 2004-247493

(51) Int. Cl. G03G 15/20

(52) U.S. Cl. 428/32.38; 430/124

(57) ABSTRACT

The object of the present invention is to provide an image-receiving sheet for the electrophotography which can form an image having excellent glossiness, a little concave and convex (relief) and a high image quality compared to that of a silver salt photograph, is excellent in adhesion resistance and shelf stability, and can mitigate an environmental load during the production thereof, and also an image-forming process using the image-receiving sheet for the electrophotography. For this object, the present invention provides an image-receiving sheet for the electrophotography comprising a support and a toner image-receiving layer disposed on the support, wherein the toner image-receiving layer comprises a thermoplastic resin which is a polyester resin having a glass transition temperature (Tg) of higher than 60° C., a number average molecular weight (Mn) of 5,000 to 12,000 and the ratio (Mw/Mn) between the weight average molecular weight (Mw) and the number average molecular weight (Mn) of 1≦Mw/Mn≦3.

### BACKGROUND OF THE INVENTION

1. Field of the Invention

The present invention relates to an image-receiving sheet for the electrophotography which can form an image having excellent glossiness, a little concave and convex (relief) and a high image quality compared to that of a silver salt photograph, is excellent in adhesion resistance and shelf stability, and can mitigate an environmental load during the production thereof, and relates also to an image-forming process using the image-receiving sheet for the electrophotography.

2. Description of the Related Art

Conventionally, since the electrophotograph method is a dry treatment having a high printing rate and the electrophotograph can be out-put on a general-purpose paper (, such as a paper and a woodfree paper), the electrophotograph method is applied to a copy machine or an out-put device of the personal computer; however, when an image information, such as a humane face and a landscape, is out-put as a photograph particularly on a general-purpose paper, the produced image is poor in glossiness and relief, so that a conventional electrophotograph cannot obtain a satisfactory performance. Further, when an image-receiving sheet for the electrophotography has high adhesion properties, during the storage of the sheet, an adhesion trouble of the sheets is caused sometimes.

Therefore, various methods for improving the glossiness and relief of the image-receiving sheet for the electrophotography by smoothing the surface of the sheet, are proposed.

For example, Japanese Patent Application Laid-Open (JP-A) No. 2002-91048 discloses the viscoelastic properties of a thermoplastic resin at the temperature in the fixing nip part with respect to a transfer sheet for the electrophotography in which on a surface of the support, an image-receiving layer comprising mainly the above-noted thermoplastic resin is disposed. In Examples of the JP-A No. 2002-91048, the image-receiving layer comprises a polyester resin having a glass transition temperature (Tg) of 61° C., a number average molecular weight (Mn) of 4,000 and a molecular-weight distribution (Mw/Mn) of 3.25.

JP-A No. 08-54748 proposes a recording sheet produced by coating a transparent support with a self-dispersible hydrophilic polyester resin emulsion.

JP-A No. 09-22136 proposes a film to which the image is transferred for the electrophotography produced by disposing an image-receiving layer comprising a polyester resin having a specific composition on at least one surface of a transparent support.

JP-A No. 2000-305305 proposes a image-receiving medium for the electrophotography comprising a support and an image-receiving layer which comprises a water-soluble polyester resin and/or a water-dispersible polyester resin which have a molecular weight of 1,000 to 2,000 and a glass transition temperature of 60° C. or less.

JP-A No. 2001-154395 proposes an image-receiving sheet produced by disposing an image-receiving layer comprising at least a polyester resin which comprises terephthalic acid (TPA) and ethylene glycol (EG) on at least one surface of a support film.

However, by the above-noted conventional methods, the glossiness and the concave and convex (relief) of the image cannot be caused to be compatible with the adhesion resistance of the sheet and the image quality of the image-receiving sheet for the electrophotography compared to that of the silver salt photograph cannot yet be obtained, therefore further improvements and developments in the above-noted methods are desired nowadays.

### SUMMARY OF THE INVENTION

The object of the present invention is to provide an image-receiving sheet for the electrophotography which can form an image having excellent glossiness, a little concave and convex (relief) and a high image quality compared to that of a silver salt photograph, is excellent in adhesion resistance and shelf stability, and can mitigate an environmental load during the production thereof, and an image-forming process using thereof.

The image-receiving sheet for the electrophotography according to the present invention comprises a support and at least one toner image-receiving layer disposed on the support, wherein the toner image-receiving layer comprises a polyester resin having a glass transition temperature (Tg) of higher than 60° C., a number average molecular weight (Mn) of 5,000 to 12,000 and the ratio (Mw/Mn) between the weight average molecular weight (Mw) and the number average molecular weight (Mn) of 1≦Mw/Mn≦3. As the result, according to the present invention, an image-receiving sheet for the electrophotography which can form an image having excellent glossiness, a little concave and convex (relief) and a high image quality compared to that of a silver salt photograph, is excellent in adhesion resistance and shelf stability, and can mitigate an environmental load during the production thereof, can be obtained.

The image-forming process according to the present invention comprises forming a toner image in the toner image-receiving sheet for the electrophotography according to the present invention and fixing the toner image formed in the forming of the toner image by smoothing the surface of the toner image. According to the image-forming process of the present invention, by a simple treatment, an image having a high image quality compared to that of the silver salt photograph print can be effectively produced.

According to the above-noted image-forming process, even if by using an image-forming apparatus equipped with no fixing oil, not only a stable feed of the sheet without causing an off-set of the image to the fixing roll or to the fixing belt can be obtained, but also an excellent image having a more excellent glossiness than that of conventional images, which is rich in photographic sense can be obtained.

### BRIEF DESCRIPTION OF THE DRAWING

FIG. 1 is a schematic view showing an example of the apparatus configured to fix the image by smoothing the image surface according to the present invention.

FIG. 2 is a schematic view showing an example of the image-forming apparatus according to the present invention.

FIG. 3 is a schematic view showing an example of the apparatus configured to fix the image by smoothing the image surface in FIG. 2.

### DESCRIPTION OF THE PREFERRED EMBODIMENTS

(Image-Receiving Sheet for Electrophotography)

The image-receiving sheet for the electrophotography according to the present invention comprises a support, at least a toner image-receiving layer disposed on the support, and optionally other layers selected properly depending on the application, such as an intermediate layer, a protective layer, a back layer, an undercoating layer, a cushion layer, a charge-controlling (preventing) layer, a reflective layer, a tint-controlling layer, a shelf stability-improving layer, an anti-adhesion layer, an anti-curling layer and a smoothing layer. These layers may be in a single layer structure or a laminated structure of plural layers.

[Support]

Examples of the support include a raw paper, a synthetic paper, a synthetic resin sheet, a coated paper and a laminated paper. Among them, the support produced by disposing polyolefin resin layers on the both surfaces of the raw paper is preferred from the viewpoint of water resistance, preventing the curling, hand feeling and nerve strength of the sheet. The support may be in a single layer structure or a laminated structure of plural layers.

Raw Paper

The raw paper is not restricted and may be properly selected depending on the application. Preferred specific examples of the raw paper include a woodfree paper, such as a paper described in the literature “Basis of Photographic Technology-silver halide photograph (edited by The Society of Photographic Science and Technology of Japan and published by Corona Publishing Co., Ltd. (1979) (pp. 223-224)”.

The raw paper is not restricted so long as the raw paper is a conventional material used for producing the support and may be properly selected from various materials depending on the application. Examples of the material for the raw paper include a natural pulp made from a needle-leaf tree or a broadleaf tree and a mixture of the natural pulp and the synthetic pulp.

As a pulp which can be used as a material for the raw paper, from the viewpoint of improving simultaneously the surface smoothness, the stiffness and the dimensional stability (curling properties) of the raw paper in a good balance and to a satisfactory level, broadleaf tree bleached craft pulp (LBKP) is preferred. Needle-leaf bleached craft pulp (NBKP) and broadleaf tree sulfite pulp (LBSP) can be also used.

For beating the pulp, a beater or a refiner can be used.

From the viewpoint of suppressing the shrinkage of the paper in the papermaking, the Canadian Standard Freeness (CSF) of the pulp is preferably from 200 to 440 ml CSF, more preferably from 250 to 380 ml CSF.

The pulp slurry (hereinafter, occasionally referred to as “pulp paper material”) which is obtained after beating the pulp comprises optionally various additives, such as a filler, a dry paper reinforcer, a sizing agent, a wet paper reinforcer, an adhesion promoter, a pH controller and other agents.

Examples of the filler include calcium carbonate, clay, kaolin, white clay, talc, titanium oxide, diatomaceous earth, barium sulfate, aluminum hydroxide and magnesium hydroxide.

Examples of the dry paper reinforcer include cationic starch, cationic polyacrylamide, anionic polyacrylamide, amphoteric polyacrylamide, carboxy-modified polyvinyl alcohol.

Examples of the sizing agent include an fatty acid salt; rosin derivatives, such as rosin and maleic rosin; paraffin wax; and a compound containing a higher fatty acid, such as an alkyl ketene dimmer, an alkenyl succinic anhydride (ASA) and an epoxidized fatty amide.

Examples of the wet paper reinforcer include a polyamidepolyamineepichlorohydrin resin, a melamine resin, a urea resin and an epoxidized polyamide resin.

Examples of the adhesion promoter include a multivalent metal salt, such as aluminum sulfate and aluminum chloride; and a cationic polymer, such as a cationic starch.

Examples of the pH controller include caustic soda and sodium carbonate.

Examples of the other agents include an anti-foaming agent, a dye, a slime control agent and a fluorescent whitening agent.

Further optionally, the pulp slurry may comprise a flexibilizer. Examples of the flexibilizer include an agent described in the literature “Paper and Paper Treatment Manual (published by Shiyaku Time Co., Ltd. (1980) (pp. 554-555)).

These various additives may be used individually or in combination. The amount of the various additives in the pulp paper material is not restricted and may be selected properly depending on the application. The amount is preferably 0.1% to 1.0% by mass, based on the mass of the pulp paper material.

The pulp paper material (which is optionally prepared by incorporating the various additives into the pulp slurry) is subjected to the papermaking using a paper machine, such as a manual paper machine, a Fourdrinier (long-net) paper machine, a round-net paper machine, a twin-wire machine and a combination machine, and the made paper is dried to produce the raw paper. If desired, either before or after the drying of the made paper, the made paper may be subjected to the surface sizing treatment.

The treating liquid used for the surface sizing treatment is not restricted and may be properly selected depending on the application. Examples of the compound contained in the treating liquid include a water-soluble polymer, a waterproof compound, a pigment, a dye and a fluorescent whitening agent.

Examples of the water-soluble polymer include a cationic starch, a polyvinyl alcohol, a carboxy-modified polyvinyl alcohol, a carboxymethylcellulose, a hydroxyethylcellulose, a cellulose sulfate, gelatin, casein, a sodium polyacrylate, a sodium salt of styrene-maleic anhydride copolymer and a sodium salt of polystyrenesulfonic acid.

Examples of the waterproof compound include latexes and emulsions, such as a styrene-butadiene copolymer, an ethylene-vinyl acetate copolymer, a polyethylene and a vinylidene chloride copolymer; and a polyamidepolyamineepichlorohydrin.

Examples of the pigment include calcium carbonate, clay, kaolin, talc, barium sulfate and titanium oxide.

From the viewpoint of improving stiffness and dimensional stability (curling properties) of the raw paper, it is preferred that the raw paper has the ratio (Ea/Eb) between the longitudinal Young's modulus (Ea) and the lateral Young's modulus (Eb) of from 1.5 to 2.0. When the ratio (Ea/Eb) is less than 1.5 or more than 2.0, the stiffness and the curling properties of the image-receiving sheet for the electrophotography may be easily impaired, so that a disadvantage is caused wherein the conveyability of the image-receiving sheet for the electrophotography is hindered.

Generally, it has been clarified that the “nerve” of the paper is varied depending on the method for beating the pulp and as an important index indicating the “nerve” of the paper, the modulus of elasticity of the paper made by the papermaking after the beating of the pulp, can be used. The modulus of elasticity of the paper can be calculated according to the following equation:
E=ρc²(1−n²)
where “E” represents dynamic modulus, “p” represents the density of the paper, “c” represents the velocity of sound in the paper, and “n” represents the Poisson's ratio,
   by using the relation between the dynamic modulus of the paper indicating the properties as a viscoelastic body and the density of the paper, and the velocity of sound in the paper measured using an ultrasonic oscillator.

In addition, since n=0.2 or so with respect to an ordinary paper, there is not much difference between the calculation of the dynamic modulus according to the above-noted equation and the calculation according to the following equation:
E=ρc².

Accordingly, when the density of the paper and the velocity of sound in the paper can be measured, the elastic modulus of the paper can be easily calculated. For measuring the velocity of sound in the paper, various conventional instruments, such as a Sonic Tester SST-110 (Manufactured and sold by Nomura Shoji Co., Ltd.) can be used.

For imparting a desired mean center line roughness to the surface of the raw paper, it is preferred that the raw paper is produced, as described in JP-A No. 58-68037, using a pulp fiber having a fiber length distribution in which a total of a 24 mesh screen remnant and a 42 mesh screen remnant is from 20 to 45% by mass and a 24 mesh screen remnant is 5% by mass or less, based on the mass of all pulp fibers. Moreover, the mean center line roughness of the raw paper can be controlled by subjecting the raw paper to a surface treatment by applying the heat and pressure using a machine calendar or a super calendar.

The thickness of the raw paper is not restricted and may be properly selected depending on the application. The thickness is usually preferably from 30 μm to 500 μm, more preferably from 50 μm to 300 μm, still more preferably from 100 μm to 250 μm. The basis weight of the raw paper is not restricted and may be properly selected depending on the application. The basis weight is preferably from 50 g/m² to 250 g/m², more preferably from 100 g/m² to 200 g/m².

Synthetic Paper

The synthetic paper is a paper comprising mainly another polymer fiber than a cellulose and examples of the another polymer fiber include a polyolefin fiber, such as a polyethylene fiber and a polypropylene fiber.

Synthetic Resin Sheet (Film)

Examples of the synthetic resin sheet include a synthetic resin shaped into the form of sheet, such as a polypropylene film, an oriented polyethylene film, an oriented polypropylene film, a polyester film, an oriented polyester film and a nylon film. In addition, a film whitened by orienting the film and a white film comprising a white pigment can be also used.

Coated Paper

The coated paper is a paper produced by coating either a single surface or the both surfaces of the support, such as the raw paper with various resins and the amount of a resin as a coating material is varied depending on the application of the coated paper. Examples of the coated paper include an art paper, a cast-coated paper and a Yankee paper.

The resin with which the surface of the raw paper is coated is not restricted and may be properly selected depending on the application. The resin is preferably a thermoplastic resin. Examples of the thermoplastic resin include (1) polyolefin resins and derivatives thereof, (2) polystyrene resins, (3) acrylic resins, (4) a polyvinyl acetate and derivatives thereof, (5) polyamide resins, (6) a polyester resin, (7) a polycarbonate resin, (8) a polyether resin (or an acetal resin), and (9) other resins. These thermoplastic resins may be used individually or in combination.

Examples of the polyolefin resins (1) include a polyolefin resin, such as a polyethylene and a polypropylene; and a copolymer resin produced by copolymerizing an olefin, such as ethylene and propylene with another vinyl monomer. Examples of such a copolymer resin (produced by copolymerizing an olefin with another vinyl monomer) include an ethylene-vinyl acetate copolymer and an ionomer resin which is produced by copolymerizing an olefin with acrylic acid or methacrylic acid. Examples of the derivatives of the polyolefin resins include a chlorinated polyethylene and a chlorosulfonated polyethylene.

Examples of the polystyrene resins (2) include a polystyrene resin, a styrene-isobutylene copolymer, an acrylonitrile-styrene copolymer (AS resin), an acrylonitrile-butadiene-styrene copolymer (ABS resin) and a polystyrene-maleic anhydride resin.

Examples of the acrylic resins (3) include a polyacrylic acid and esters thereof, a polymethacrylic acid and esters thereof, a polyacrylonitrile and a polyacrylamide. The properties of an ester of the poly(meth)acrylic acid are largely varied depending on the type of an ester group contained in the ester of the poly(meth)acrylic acid. Also, examples of the acrylic resins (3) include a copolymer produced by copolymerizing, for example, acrylic (methacrylic) acid with another monomer (e.g., methacrylic (acrylic) acid, a styrene and a vinyl acetate). The polyacrylonitrile is used more frequently as a material of the As resin or the ABS resin than as a homopolymer (i.e., as it is).

Examples of a polyvinyl acetate and derivatives thereof (4) include a polyvinyl acetate, a polyvinyl alcohol produced by saponifying the polyvinyl acetate and a polyvinylacetal resin produced by reacting the polyvinyl alcohol with an aldehyde (e.g., formaldehyde, acetaldehyde and butyraldehyde).

The polyamide resins (5) are polycondensates of a diamine and a dibasic acid and examples thereof include 6-nylon and 6,6-nylon.

The polyester resin (6) is a polycondensate of an acid and an alcohol and the properties of the polyester resin are largely varied depending on the type of the combination of an acid and an alcohol. Specific examples of the polyester resin (6) include a versatile resin produced from an aromatic dibasic acid and a bifunctional alcohol, such as a polyethyleneterephthalate and a polybutylenephthalate.

General examples of the polycarbonate resin (7) include a polycarbonate ester produced from bisphenol A and phosgene.

Examples of the polyether resin (or the acetal resin) (8) include a polyether resin, such as a polyethylene oxide and a polypropylene oxide (or an acetal resin produced by a ring opening polymerization, such as a polyoxymethylene).

The other resins (9) include a polyurethane resin produced by an addition polymerization.

The thermoplastic resin may optionally comprise a brightener, a conductive filler, a filler, titanium oxide, and a pigment or dye, such as a ultramarine and a carbon black.

Laminated Paper

The laminated paper is a paper produced by laminating a material for the laminating, such as various resins, a rubber, a polymer sheet or a polymer film on the surface of the support, such as the raw paper. Examples of the material for the laminating include a polyolefin resin, a polyvinyl chloride resin, a polyester resin, a polystyrene resin, a polymethacrylate resin, a polycarbonate resin, a polyimide resin and a triacetyl cellulose. These resins may be used individually or in combination.

The polyolefin resin is, in general, frequently produced using a low-density polyethylene. For improving heat resistance of the support, however, it is preferred to produce the polyolefin resin using a polypropylene resin, a mixture of a polypropylene resin and a polyethylene resin, a high-density polyethylene resin or a mixture of a high-density polyethylene resin and a low-density polyethylene resin. Particularly from the viewpoint of the cost and laminatability, it is most preferred to produce the polyolefin resin using the mixture of a high-density polyethylene resin and a low-density polyethylene resin.

The mixing ratio (in terms of the mass ratio) between the high-density polyethylene and the low-density polyethylene is preferably from 1:9 to 9:1, more preferably from 2:8 to 8:2, still more preferably from 3:7 to 7:3.

For disposing thermoplastic resin layers on the both surfaces of the raw paper, it is preferred that on the back surface of the raw paper, a thermoplastic resin layer is disposed using a high-density polyethylene resin or a mixture of a high-density polyethylene resin and a low-density polyethylene resin. The molecular weight of the polyethylene resin is not restricted and may be properly selected depending on the application; however, it is preferred that the polyethylene resin is produced using a high-density polyethylene resin and a low-density polyethylene resin and both of them have the melt index of from 1.0 g/10 min to 40 g/10 min and have extrudability.

The polymer sheet or the polymer film as the above-noted materials for the laminating may be subjected to a treatment of imparting white reflectivity. Examples of such a treatment include a method for incorporating a pigment, such as titanium oxide in the composition of the polymer sheet or the polymer film.

The support has a thickness of preferably from 25 μm to 300 μm, more preferably from 50 μm to 260 μm, still more preferably from 75 μm to 220 μm. The stiffness of the support may be selected depending on the application. The support for producing the image-receiving sheet for the electrophotography has preferably a similar stiffness to the stiffness which the support for producing the image-receiving sheet for the color silver salt-photography has.

[Toner Image-Receiving Layer]

The toner image-receiving layer receives a color toner and a black toner, and forms the image. The toner image-receiving layer has a function of receiving the toner for forming the image from a developing drum or an intermediate transfer medium by (static) electricity or pressure during the transferring and a function of fixing the image by heat or pressure during the fixing.

The toner image-receiving layer comprises a thermoplastic resin. As the thermoplastic resin, a polyester resin is used. The polyester resin has preferably a glass transition temperature (Tg) of higher than 60° C., a number average molecular weight (Mn) of 5,000 to 12,000 and the ratio (Mw/Mn) between the weight average molecular weight (Mw) and the number average molecular weight (Mn) of 1≦Mw/Mn≦3.

The polyester resin has more preferably a glass transition temperature (Tg) of 61° C. to 100° C., a number average molecular weight (Mn) of 5,000 to 10,000 and the ratio (Mw/Mn) between the weight average molecular weight (Mw) and the number average molecular weight (Mn) of 1.2≦Mw/Mn≦2.5.

When the polyester resin has a glass transition temperature (Tg) of out of the above-noted range, a number average molecular weight of out of the above-noted range or the ratio (Mw/Mn) of out of the above-noted range, it becomes sometimes difficult to cause the glossiness and the relief of the toner image to be compatible with the adhesion resistance of the toner image-receiving sheet.

The above-noted polyester resin is produced by a polycondensation of an acid component and an alcohol component. The acid component is not restricted and may be properly selected depending on the application. Examples of the acid component include maleic acid, fumaric acid, citraconic acid, itaconic acid, glutaconic acid, phthalic acid, terephthalic acid, isophthalic acid, succinic acid, adipic acid, sebacic acid, azelaic acid, malonic acid, n-dodecenylsuccinic acid, isododecenylsuccinic acid, n-dodecylsuccinic acid, isododecylsuccinic acid, n-octenylsuccinic acid, n-octylsuccinic acid, isooctenylsuccinic acid, isooctylsuccinic acid, and anhydrides of these acids and esters of these acids with lower alkyls.

The alcohol component is not restricted and may be properly selected depending on the application. Preferred examples of the alcohol component include a dihydric alcohol, such as a fatty diol and an alkylene oxide adduct of a bisphenol A. Examples of the fatty diol include ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol, and polytetramethylene glycol. Examples of the alkylene oxide adduct of the bisphenol A include polyoxypropylene (2.2)-2,2-bis(4-hydroxyphenyl)propane, polyoxypropylene (3.3)-2,2-bis(4-hydroxyphenyl)propane, polyoxyethylene (2.0)-2,2-bis(4-hydroxyphenyl)propane, polyoxypropylene (2.0)-polyoxyethylene (2.0)-2,2-bis(4-hydroxyphenyl)propane and polyoxypropylene (6)-2,2-bis(4-hydroxyphenyl)propane.

According to the present invention, the polyester resin is preferably a self-dispersible hydrophilic polyester resin emulsion, most preferably a self-dispersible hydrophilic polyester resin emulsion of a carboxyl group type. Here, the self-dispersible hydrophilic polyester resin emulsion means an aqueous emulsion comprising a polyester resin which can self-disperse in an aqueous solvent without using an emulsifying agent and the self-dispersible hydrophilic polyester resin emulsion of a carboxyl group type means an aqueous emulsion comprising a polyester resin which can self-disperse in an aqueous solvent and has a carboxyl group as a hydrophilic group.

The manufacturing method of the self-dispersible hydrophilic polyester resin emulsion is not restricted and may be properly selected depending on the application. Examples of the manufacturing method include a method (1) disclosed in JP-A No. 05-295100 and a method (2) disclosed in JP-A No. 2002-173582.

<Method (1) Disclosed in JP-A No. 05-295100>

The method (1) comprises dissolving a polyester resin having a glass transition temperature of higher than 60° C., a number average molecular weight (Mn) of 5,000 to 12,000 and the ratio (Mw/Mn) between the weight average molecular weight (Mw) and the number average molecular weight (Mn) of 1≦Mw/Mn≦3 into a ketone-type solvent, adding to the resultant solution a neutralizing agent to ionize a carboxyl group of the polyester resin, adding water to the solution and distilling off the ketone-type solvent to transfer the polyester resin to the aqueous phase.

More specifically, the above-noted polyester resin emulsion can be obtained as follows. First, a reactor equipped with a stirrer, a reflux condenser, a thermometer, a dropping funnel and a nitrogen gas introducing tube is prepared. Into the reactor, a specified polyester resin dissolved in a ketone-type solvent is introduced and next, into the solution, a neutralizing agent is added to ionize the carboxyl group of the polyester resin (when the carboxyl group is already ionized beforehand, this step is unnecessary). Consequently, to the solution, water is added and the ketone-type solvent is distilled off to transfer the polyester resin into the aqueous phase, thereby obtaining an aqueous emulsion of the specified polyester resin. Dissolving the polyester resin into a ketone-type solvent and adding a neutralizing agent are performed at a temperature which is a boiling point of an usual ketone-type solvent or lower.

Examples of the water used here include an ion-exchanged water. The amount of the water is preferably 100 parts by mass to 2,000 parts by mass, relative to 100 parts by mass of the polyester resin.

Examples of the ketone-type solvent include acetone, methyl ethyl ketone, diethyl ketone, dipropyl ketone, methyl isobutyl ketone and methyl isopropyl ketone. Among them, methyl ethyl ketone is preferred. The ketone-type solvent can be used in the range where the ketone-type solvent can dissolve the polyester resin.

Examples of the neutralizing agent include an ammonia water; an aqueous solution of an alkali, such as sodium hydroxide; and an amine, such as an allyl amine, isopropylamine, diisopropylamine, ethylamine, diethylamine, triethylamine, 2-ethylhexylamine, 3-ethoxypropylamine, diisobutylamine, 3-diethylaminopropylamine, tri-n-octylamine, t-butylamine, sec-butytlamine, propylamine, methylaminopropylamine, dimethylaminopropylamine, n-propanolamine, butanolamine, 2-amino-4-pentanol, 2-amino-3-hexanol, 5-amino-4-octanol, 3-amino-3 methyl-2-butanol, monoethanolamine, isopropanolamine, neopentanolamine, diglycolamine, ethylenediamine, 1,3-diaminopropane, 1,2-diaminopropane, 1,6-diaminopropane, 1,6-diaminohexane, 1,9-diaminononane, 1,12-diaminododecane, a dimmer of fatty acid diamine, 2,2,4-trimethylhexamethylenediamine, 2,4,4-trimethylhexamethylenediamine, hexamethylenediamine, N-aminoethyl piperazine, N-aminopropyl piperazine, N-aminopropyl dipiperazipropane and piperazine. Among them, triethylamine and an aqueous solution of sodium hydroxide are most preferred.

The amount of the neutralizing agent may be an amount by which at least the acid value of the polyester resin can be neutralized. More specifically, since the amount is varied depending on the type and concentration of the polyester resin used, it cannot be sweepingly mentioned; however, for example when triethylamine is used as the neutralizing agent, the amount of the neutralizing agent is properly 1 to 2 times an amount by which the acid value of the polyester resin can be neutralized.

The amount ratio of each component is not restricted so long as the carboxyl group can be ionized and the polyester resin can be transferred to the aqueous phase and when in the above-noted amount ratio, the above-noted steps are performed, a desired self-dispersible hydrophilic polyester resin emulsion can be obtained.

<Method (2) Disclosed in JP-A No. 2002-173582>

The method (2) comprises mixing a polyester resin having a glass transition temperature of higher than 60° C., a number average molecular weight (Mn) of 5,000 to 12,000 and the ratio (Mw/Mn) between the weight average molecular weight (Mw) and the number average molecular weight (Mn) of 1≦Mw/Mn≦3, a hydrophilic organic solvent, a neutralizing agent for ionizing the carboxyl group of the polyester resin (when the carboxyl group is already ionized beforehand, this agent is unnecessary) and water, and heating-stirring the resultant mixture at 40° C. to 100° C. for several minutes to several hours. When the temperature of the heating is higher than 100° C., the viscosity of the self-dispersible hydrophilic polyester resin emulsion is largely elevated, so that the workability of the production of the polyester resin emulsion is adversely affected.

Examples of the water include an ion-exchanged water. The amount of the water is preferably 100 parts by mass to 2,000 parts by mass, relative to 100 parts by mass of the polyester resin.

Examples of the hydrophilic organic solvent include alcohols, such as ethanol, n-propanol, isopropanol, n-butanol, isobutanol, sec-butanol, tert-butanol, n-amyl alcohol, isoamyl alcohol, sec-amyl alcohol, tert-amyl alcohol, 1-ethyl-1-propanol, 2-methyl-1-butanol, n-hexanol and cyclohexanol; ketones, such as acetone, methyl ethyl ketone, methyl isobutyl ketone, ethyl butyl ketone, cyclohexanone and isophorone; ethers, such as tetrahydrofuran and dioxane; esters, such as ethyl acetate, n-propyl acetate, isopropyl acetate, n-butyl acetate, isobutyl acetate, sec-butyl acetate, 3-methoxybutyl acetate, methyl propionate, ethyl propionate, diethyl carbonate and dimethyl carbonate; glycol derivatives, such as ethylene glycol, ethylene glycol monomethyl ether, ethylene glycol monoethyl ether, ethylene glycol monopropyl ether, ethylene glycol monobutyl ether, ethylene glycol ethyl ether acetate, diethylene glycol, diethylene glycol monomethyl ether, diethylene glycol monoethyl ether, diethylene glycol monobutyl ether, diethylene glycol ethyl ether acetate, propylene glycol, propylene glycol monomethyl ether, propylene glycol monoethyl ether, propylene glycol monobutyl ether and propylene glycol methyl ether acetate; 3-methoxy-3-methylbutanol, 3-methoxybutanol, acetonitrile, dimethylformamide, dimethylacetoamide, diacetone alcohol and ethyl acetoacetate. Among them, isopropanol is most preferred.

The amount of the hydrophilic organic solvent is preferably 20 parts by mass to 100 parts by mass, relative to 100 parts by mass of the polyester resin.

Examples of the neutralizing agent include ammonia, triethylamine, N,N-diethyl ethanolamine, N,N-dimethyl ethanolamine, amino ethanolamine, N-methyl-N,N-diethanol amine, isopropylamine, iminobispropylamine, ethylamine, diethylamine, 3-ethoxypropylamine, 3-diethylaminopropylamine, sec-butylamine, propylamine, methylaminopropylamine, dimethylaminopropylamine, methyliminobispropylamine, 3-methoxypropylamine, monoethanol amine, diethanol amine, triethanol amine, morpholine, N-methylmorpholine and N-ethylmorpholine. Among them, ammonia and triethylamine are most preferred.

The amount of the neutralizing agent may be an amount by which at least the acid value of the polyester resin can be neutralized. More specifically, since the amount is varied depending on the type and concentration of the polyester resin used, it cannot be sweepingly mentioned; however, for example when triethylamine is used as the neutralizing agent, the amount of the neutralizing agent is properly 0.8 to 2 times an amount by which the acid value of the polyester resin can be neutralized.

The amount ratio of each component is not restricted so long as the carboxyl group can be ionized and the polyester resin can be transferred to the aqueous phase and when in the above-noted amount ratio, the above-noted steps are performed, a desired self-dispersible hydrophilic polyester resin emulsion can be obtained.

The stirring unit used for the above-noted heating-stirring is not restricted so long as by the unit, a liquid can be stirred; however, from the viewpoint of obtaining in a short time the self-dispersible hydrophilic polyester resin emulsion, it is preferred that a stirring unit which is applicable to the high-speed rotation and the high-speed shearing, such as a homomixer and a homodisper is used. Usually, the stirring unit is equipped with a simple cover and is used under normal pressure or slightly super-atmospheric pressure. Optionally, a stirring unit which can apply a pressure of 0.1 MPa or more may be used.

Further optionally, by distilling off the organic solvent from the obtained emulsion, a self-dispersible hydrophilic polyester resin emulsion in which the content of the organic solvent is lowered can be obtained.

The distilling-off method of the organic solvent is not restricted and examples of the method include a method comprising introducing the self-dispersible hydrophilic polyester resin emulsion into a stirring unit which can stir a liquid and heating the self-dispersible hydrophilic polyester resin emulsion under normal pressure or reduced pressure, thereby distilling off easily the organic solvent.

According to the method (2), in comparison with a transferring-to-water phase method using a large amount of the organic solvent, by using a small amount of the organic solvent, a self-dispersible hydrophilic polyester resin emulsion having a high solid concentration can be obtained and the method is extremely economical.

With respect to the thus obtained self-dispersible hydrophilic polyester resin emulsion, the particle diameter of the resin is preferable 0.001 μm to 10.0 μm, more preferably 0.001 μm to 1.0 μm, still more preferably 0.001 μm to 0.3 μm, most preferably 0.01 μm to 0.25 μm.

The solid concentration of the obtained self-dispersible hydrophilic polyester resin emulsion is preferably 5% by mass to 50% by mass.

The toner image-receiving layer may comprise besides the above-noted polyester resin, other resins which are preferably excellent in the compatibility with the toner. Examples of the other resins include a polyolefin resin, such as a polyethylene and a polypropylene; a vinyl resin, such as a polyvinyl chloride, a polyvinylidene chloride, a polyvinyl acetate, a copolymer of vinyl chloride and vinyl acetate, a polyacrylate and a polystyrene; a polyamide resin; a copolymer of an olefin (, such as ethylene and propylene) and another vinyl monomer; an ionomer resin; a cellulose resin, such as an ethyl cellulose and a cellulose acetate; a polycarbonate resin; an epoxy resin; and a phenoxy resin.

The toner image-receiving layer comprises at least the above-noted particles and the above-noted polymer used for the toner image-receiving layer, and optionally various additives. Examples of the other components which the toner image-receiving layer comprises include various additives used for improving thermodynamic properties of the toner image-receiving layer, such as a releasing agent, a plasticizer, a colorant, a filler, a cross-linking agent, a charge control agent, an emulsifier and a dispersant.

Releasing Agent

The releasing agent is incorporated in the composition of the toner image-receiving layer for preventing the offset of the toner image-receiving layer. The releasing agent of the present invention is not restricted and may be properly selected depending on the application so long as it is melted or fused by heating at the temperature for the image-fixing and is disposed on the surface of the toner image-receiving layer as a layer of the releasing agent by cooling and solidifying.

Examples of the releasing agent include a silicone compound, a fluorine compound, a wax and a matting agent (i.e., the above-noted particles according to the present invention).

Examples of the releasing agent include also the compounds described in the literatures “Properties and Applications of Waxes, Revised Edition” (published by Saiwai Shobo) and “The Silicon Handbook”(published by THE NIKKAN KOGYO SHIMBUN). Further, preferred examples of the releasing agent include silicon compounds, fluorine compounds and waxes (except natural waxes) which are used for producing toners which are described in the following patent documents: JP-B Nos. 59-38581, 04-32380, Japanese Patent Nos. 2838498 and 2949558, JP-A Nos. 50-117433, 52-52640, 57-148755, 61-62056, 61-62057, 61-118760, 02-42451, 03-41465, 04-212175, 04-214570, 04-263267, 05-34966, 05-119514, 06-59502, 06-161150, 06-175396, 06-219040, 06-230600, 06-295093, 07-36210, 07-43940, 07-56387, 07-56390, 07-64335, 07-199681, 07-223362, 07-287413, 08-184992, 08-227180, 08-248671, 08-248799, 08-248801, 08-278663, 09-152739, 09-160278, 09-185181, 09-319139, 09-319143, 10-20549, 10-48889, 10-198069, 10-207116, 11-2917, 11-44969, 11-65156, 11-73049 and 11-194542. These compounds may be used in combination.

Examples of the silicone compound include a silicone oil, a silicone rubber, a silicone fine particles, a silicone-modified resin and a reactive silicone compound.

Examples of the silicone oil include an unmodified silicon oil, an amino-modified silicone oil, a carboxy-modified silicone oil, a carbinol-modified silicone oil, a vinyl-modified silicone oil, an epoxy-modified silicone oil, a polyether-modified silicone oil, a silanol-modified silicone oil, a methacryl-modified silicone oil, a mercapto-modified silicone oil, an alcohol-modified silicone oil, an alkyl-modified silicone oil and a fluorine-modified silicone oil.

Examples of the silicone-modified resin include silicone-modified resins produced by silicone-modifying resins, such as an olefinic resin, a polyester resin, a vinyl resin, a polyamide resin, a cellulose resin, a phenoxy resin, a vinyl chloride-vinyl acetate resin, an urethane resin, an acrylic resin, a styrene-acrylic resin and a copolymer resin thereof.

The fluorine compound is not restricted and may be properly selected depending on the application. Examples of the fluorine compound include a fluorocarbon oil, a fluorocarbon rubber, a fluorine-modified resin, a fluorosulfonic acid compound, a fluorosulfonic acid, a fluoric acid compound and salts thereof and an inorganic fluoride.

The wax is generally classified into a natural wax and a synthesized wax.

Preferred examples of the natural wax include a vegetable wax, an animal wax, a mineral wax and a petroleum wax. Among them, the vegetable wax is most preferred. As the natural wax, particularly from the viewpoint of the compatibility of the wax with a hydrophilic resin used as the polymer for producing the toner image-receiving layer, a water-dispersible natural wax is preferred.

The vegetable wax is not restricted and may be properly selected from conventional vegetable waxes which may be properly synthesized or commercially available. Examples of the vegetable wax include a carnauba wax, a castor oil, a rape oil, a soy bean oil, a Japan tallow, a cotton wax, a rice wax, a sugarcane wax, a candelilla wax, a Japan wax and a jojoba oil.

Examples of the carnauba wax which is commercially available include EMUSTAR-0413 (manufactured and sold by Nippon Seiro Co., Ltd.) and SELOSOL 524 (manufactured and sold by Chukyo Yushi Co., Ltd.). Examples of the castor oil which is commercially available include a purified castor oil (manufactured and sold by Itoh Oil Chemicals Co., Ltd).

Among them, particularly from the viewpoint of providing an image-receiving sheet for the electrophotography which is excellent particularly in anti-offset properties, adhesion resistance, conveyability and glossiness, and in which the crazing is hardly caused and an image having a high quality can be formed, the carnauba wax having a melting point of from 70 to 95° C. is most preferred.

The animal wax is not restricted and may be properly selected from conventional animal waxes. Examples of the animal wax include a bees wax, a lanolin, a spermaceti wax, a whale oil and a wool wax.

The mineral wax is not restricted and may be properly selected form conventional mineral waxes which may be commercially available or properly synthesized. Examples of the mineral wax include a montan wax, a montan ester wax, an ozokerite and a ceresin.

Among them, particularly from the viewpoint of providing an image-receiving sheet for the electrophotography which is excellent particularly in anti-offset properties, adhesion resistance, conveyability and glossiness, and in which the crazing is hardly caused and an image having a high quality can be formed, the montan wax having a melting point of from 70 to 95° C. is most preferred.

The petroleum wax is not restricted and may be properly selected conventional petroleum waxes which may be commercially available or properly synthesized. Examples of the petroleum wax include a paraffin wax, a microcrystalline wax and a petrolatum.

The amount of the natural wax in the toner image-receiving layer is preferably from 0.1 g/m² to 4 g/m², more preferably from 0.2 g/m² to 2 g/m².

When the amount is less than 0.1 g/m², the anti-offset properties and the adhesion resistance of the image-receiving sheet may be particularly impaired. On the other hand, when the amount is more than 4 g/m², the quality of the image formed on the image-receiving sheet may be impaired due to excessive wax.

The melting point of the natural wax is, particularly from the viewpoint of the anti-offset properties and the conveyability of the image-receiving sheet, preferably from 70° C. to 95° C., more preferably from 75° C. to 90° C.

The synthetic wax is classified into a synthetic hydrocarbon, a modified wax, a hydrogenated wax and other synthetic waxes produced from fats and oils. As the wax, from the viewpoint of the compatibility of the wax with a hydrophilic thermoplastic resin used as a thermoplastic resin for producing the toner image-receiving layer, a water-dispersible wax is preferred.

Examples of the synthetic hydrocarbon include a Fischer-Tropsch wax and a polyethylene wax.

Examples of the synthetic wax produced from fats and oils include an acid amide (, such as stearamide) and an acid imide (, such as anhydrous phthalimide).

The modified wax is not restricted and may be properly selected depending on the application. Examples of the modified wax include an amine-modified wax, an acrylic acid-modified wax, a fluorine-modified wax, an olefin-modified wax, a urethane-type wax and an alcohol-type wax.

The hydrogenated wax is not restricted and may be properly selected depending on the application. Examples of the hydrogenated wax include a hard castor oil, a castor oil derivative, stearic acid, lauric acid, myristic acid, palmitic acid, behenic acid, sebacic acid, undecylenic acid, heptyl acid, maleic acid and a highly maleinated oil.

The above-noted matting agent is not restricted and may be properly selected from conventional matting agents depending on the application. Examples of solid particles used as a matting agent include inorganic particles and organic particles. Specific examples of the inorganic particles used as an inorganic matting agent include particles of an oxide (, such as silicone dioxide, titanium oxide, magnesium oxide and aluminum oxide), an alkaline earth metal salt (, such as barium sulfate, calcium sulfate and magnesium sulfate), a silver halide (, such as silver chloride and silver bromide) and a glass.

Examples of the inorganic matting agent comprising the inorganic particles include matting agents described in patent documents, such as West German Patent No. 2529321, G.B. Patent Nos. 760775 and 1260772, and U.S. Pat. Nos. 1,201,905, 2,192,241, 3,053,662, 3,062,649, 3,257,206, 3,322,555, 3,353,958, 3,370,951, 3,411,907, 3,437,484, 3,523,022, 3,615,554, 3,635,714, 3,769,020, 4,021,245 and 4,029,504.

Examples of the organic particles used as an organic matting agent include particles of a starch, a cellulose ester (e.g., a cellulose acetate propionate), a cellulose ether (e.g., ethyl cellulose) and a synthetic resin. The synthetic resin is preferably a water-insoluble resin or a water-slightly soluble resin. Examples of the water-insoluble resin or the water-slightly soluble resin include a poly(meth)acrylate, a poly(meth)acrylamide, a polyvinyl ester (, such as a polyvinyl acetate), a polyacrylonitrile, a polyolefin (, such as a polyethylene), a polystyrene resin, a benzoguanamine resin, a formaldehyde condensation resin, an epoxy resin, a polyamide resin, a polycarbonate resin, a phenol resin, a polyvinyl carbazole resin and a polyvinylidene chloride resin.

Examples of the above-noted synthetic resin include also a copolymer produced by copolymerizing monomers used for producing the above-noted homopolymers.

The above-noted copolymer may cotain a small amount of a hydrophilic recurring unit. Examples of a monomer which forms the above-noted hydrophilic recurring unit include an acrylic acid, a methacrylic acid, a α,β-unsaturated dicarboxylic acid, a hydroxyalkyl(meth)acrylate, a sulfoalkyl(meth)acrylate and a styrenesulfonic acid.

Examples of the organic matting agent comprising the organic particles include matting agents described in patent documents, such as G.B. Patent No. 1055713, U.S. Pat. Nos. 1,939,213, 2,221,873, 2,268,662, 2,322,037, 2,376,005, 2,391,181, 2,701,245, 2,992,101, 3,079,257, 3,262,782, 3,443,946, 3,516,832, 3,539,344, 3,591,379, 3,754,924 and 3,767,448, and JP-A Nos. 49-106821 and 57-14835.

These particles may be used in combination. The volume average particle diameter of the solid particles is preferably from 1 μm to 100 μm, more preferably from 4 μm to 30 μm. The amount of the solid particles is preferably from 0.01 g/m² to 0.5 g/m², more preferably from 0.02 g/m² to 0.3 g/m².

The melting point of the releasing agent is, particularly from the viewpoint of the anti-offset properties and the conbeyability of the image-receiving sheet, preferably from 70° C. to 95° C., more preferably from 75° C. to 90° C.

As the releasing agent incorporated in the composition of the toner image-receiving layer according to the present invention, a derivative, oxide, purified product and mixture of the above-exemplified releasing agents may be also used. These releasing agents may have a reactive substituent.

The amount of the releasing agent in the toner image-receiving layer is preferably 0.1% to 10% by mass, more preferably 0.3% to 8.0% by mass, still more preferably 0.5% to 5.0% by mass, based on the mass of the toner image-receiving layer.

Plasticizer

The plasticizer is not restricted and may be properly selected from conventional plasticizers used for the resin depending on the application. The plasticizer has the function to control the fluidizing and softening of the toner image-receiving layer by the heat and pressure applied on the toner image-receiving layer during fixing the toner.

Examples of a reference for selecting the plasticizer include literatures, such as “Kagaku Binran (Chemical Handbook)” (edited by The Chemical Society of Japan and published by Maruzen Co., Ltd.), “Plasticizer, Theory and Application” (edited by Koichi Murai and published by Saiwai Shobo), “Volumes 1 and 2 of Studies on Plasticizer” (edited by Polymer Chemistry Association) and “Handbook on Compounding Ingredients for Rubbers and Plastics” (edited by Rubber Digest Co.).

Some plasticizers are described as an organic solvent having a high boiling point or a thermal solvent in some literatures. Examples of the plasticizer include esters (, such as phthalate esters, phosphorate esters, fatty esters, abietate esters, adipate esters, sebacate esters, azelate esters, benzoate esters, butyrate esters, epoxidized fatty esters, glycolate esters, propionate esters, trimellitate esters, citrate esters, sulfonate esters, carboxylate esters, succinate esters, malate esters, fumarate esters, phthalate esters and stearate esters); amides (, such as fatty amides and sulfonate amides); ethers; alcohols; lactones and polyethylene oxides, which are described in patent documents, such as JP-A Nos. 59-83154, 59-178451, 59-178453, 59-178454, 59-178455, 59-178457, 62-174754, 62-245253, 61-209444, 61-200538, 62-8145, 62-9348, 62-30247, 62-136646, and 2-235694.

These plasticizers may be incorporated in the composition of the resin.

Further, a plasticizer having a relatively low molecular weight can be also used. The plasticizer has a molecular weight which is preferably lower than that of a binder resin which is plasticized by the plasticizer and preferably 15,000 or less, more preferably 5,000 or less. In addition, when a plasticizer is a polymer, the plasticizer is preferably the same polymer as that of the binder resin which is plasticized by the plasticizer. For example, for plasticizing a polyester resin, the plasticizer is preferably a polyester having a low molecular weight. Further, an oligomer can be also used as a plasticizer.

Besides the above-noted compounds, examples of the plasticizer which is commercially available include Adekacizer PN-170 and PN-1430 (manufactured and sold by Asahi Denka Kogyo Co., Ltd.); PARAPLEX G-25, G-30 and G-40 (manufactured and sold by C. P. Hall Co., Ltd.); and Ester Gum 8L-JA, Ester R-95, Pentalin 4851, FK 115, 4820, 830, Luisol 28-JA, Picolastic A75, Picotex LC and Crystalex 3085 (manufactured and sold by Rika Hercules Co., Ltd.).

The plasticizer may be optionally used for relaxating the stress and strain (i.e., a physical strain, such as a strain in elastic force and viscosity and a strain due to a material balance in the molecule and the backbone chain and pendant moiety of the binder) which are caused when the toner particles are embedded in the toner image-receiving layer.

In the toner image-receiving layer, the plasticizer may be finely (microscopically) dispersed, may be in the state of a fine phase-separation in a sea-island structure and may be compatibilized with other components, such as a binder resin.

The amount of the plasticizer in the toner image-receiving layer is preferably 0.001% by mass to 90% by mass, more preferably 0.1% by mass to 60% by mass, still more preferably 1% by mass to 40% by mass, based on the mass of the toner image-receiving layer.

The plasticizer may be used for controlling slip properties (for improving the conveyability by reducing the friction), improving the offset of the toner at the fixing part of the fixing apparatus (peeling of the toner or the toner image-receiving layer to the fixing part) and controlling the curling balance and electrostatic charge (formation of a toner electrostatic image).

Colorant

The colorant is not restricted and may be properly selected depending on the application. Examples of the colorant include a fluorescent whitening agent, a white pigment, a colored pigment and a dye.

The fluorescent whitening agent is not restricted so long as the agent is a conventional compound having the absorption in the near-ultraviolet region and emitting a fluorescence having a wavelength of 400 nm to 500 nm and may be properly selected from conventional fluorescent whitening agents. Preferred examples of the fluorescent whitening agent include the compounds described in the literature “The Chemistry of Synthetic Dyes, Volume V” (edited by K. Veen Rataraman, Chapter 8). The fluorescent whitening agent may be a commercially available product or a properly synthesized product. Examples of the fluorescent whitening agent include stilbene compounds, coumarin compounds, biphenyl compounds, benzo-oxazoline compounds, naphthalimide compounds, pyrazoline compounds and carbostyril compounds. Examples of the commercially available fluorescent whitening agent include white furfar-PSN, PHR, HCS, PCS and B (manufactured and sold by Sumitomo Chemicals Co., Ltd.) and UVITEX-OB (manufactured and sold by Ciba-Geigy Corp.).

The white pigment is not restricted and may be properly selected from conventional white pigments depending on the application. Examples of the white pigment include an inorganic pigment, such as titanium oxide and calcium carbonate.

The colored pigment is not restricted and may be properly selected from conventional colored pigments. Examples of the colored pigment include various pigments described in JP-A No. 63-44653, such as an azo pigment, a polycyclic pigment, a condensed polycyclic pigment, a lake pigment and a carbon black.

Examples of the azo pigment include an azo lake pigment (, such as carmine 6B and red 2B), an insoluble azo pigment (, such as monoazo yellow, disazo yellow, pyrazolone orange and Vulcan orange) and a condensed azo pigment (, such as chromophthal yellow and chromophthal red).

Examples of the polycyclic pigment include a phthalocyanine pigment, such as copper phthalocyanine blue and copper phthalocyanine green.

Examples of the condensed polycyclic pigment include a dioxazine pigment (, such as dioxazine violet), an isoindolinone pigment (, such as isoindolinone yellow), a threne pigment, a perylene pigment, a perinone pigment and a thioindigo pigment.

Examples of the lake pigment include malachite green, rhodamine B, rhodamine G and Victoria blue B.

Examples of the inorganic pigment include an oxide (, such as titanium dioxide and iron oxide red), a sulfate salt (, such as precipitated barium sulfate), a carbonate salt (, such as precipitated calcium carbonate) a silicate salt (, such as a hydrous silicate salt and an anhydrous silicate salt) and a metal powder (, such as aluminum powder, bronze powder, zinc powder, chrome yellow and iron blue).

These pigments may be used individually or in combination.

The dye is not restricted and may be properly selected from conventional dyes depending on the application. Examples of the dye include anthraquinone compounds and azo compounds. These dyes may be used individually or in combination.

Examples of the water-insoluble dye include a vat dye, a disperse dye and an oil-soluble dye. Specific examples of the vat dye include C. I. Vat violet 1, C. I. Vat violet 2, C. I. Vat violet 9, C. I. Vat violet 13, C. I. Vat violet 21, C. I. Vat blue 1, C. I. Vat blue 3, C. I. Vat blue 4, C. I. Vat blue 6, C. I. Vat blue 14, C. I. Vat blue 20 and C. I. Vat blue 35. Specific examples of the disperse dye include C. I. disperse violet 1, C. I. disperse violet 4, C. I. disperse violet 10, C. I. disperse blue 3, C. I. disperse blue 7 and C. I. disperse blue 58. Specific examples of the oil-soluble dye include C. I. solvent violet 13, C. I. solvent violet 14, C. I. solvent violet 21, C. I. solvent violet 27, C. I. solvent blue 11, C. I. solvent blue 12, C. I. solvent blue 25 and C. I. solvent blue 55.

Colored couplers used in the silver halide photography may also be used preferably as the dye.

The amount of the colorant in the toner image-receiving layer is preferably 0.1 g/m² to 8 g/m², more preferably 0.5 g/m² to 5 g/m².

When the amount of the colorant is less than 0.1 g/m², the light transmittance of the toner image-receiving layer may be high. On the other hand, when the amount is more than 8 g/m², handling properties, such as crazing and adhesion resistance may be impaired.

Examples of the filler include an organic filler and an inorganic filler which is a reinforcing agent for the binder resin or a conventional filler as a reinforcer or a bulking agent. The filler may be properly selected by referring to “Handbook of Rubber and Plastics Additives” (edited by Rubber Digest Co.), “Plastics Blending Agents—Basics and Applications” (New Edition) (published by Taisei Co.) and “The Filler Handbook” (published by Taisei Co.).

Examples of the filler include an inorganic filler and an inorganic pigment.

Specific examples of the inorganic filler or the inorganic pigment include silica, alumina, titanium dioxide, zinc oxide, zirconium oxide, micaceous iron oxide, white lead, lead oxide, cobalt oxide, strontium chromate, molybdenum pigments, smectite, magnesium oxide, calcium oxide, calcium carbonate and mullite. Among them, silica and alumina are most preferred. These fillers may be used individually or in combination. It is preferred that the filler has a small particle diameter. When the filler has a large particle diameter, the surface of the toner image-receiving layer is easily roughened.

Examples of the silica include a spherical silica and an amorphous silica. The silica can be synthesized by a dry method, a wet method or an aerogel method. The silica may be also produced by treating the surface of the hydrophobic silica particles with a trimethylsilyl group or silicone. Preferred examples of the silica include a colloidal silica. The silica is preferably porous.

Examples of the alumina include an anhydrous alumina and a hydrated alumina. Examples of the crystallized anhydrous alumina include α-, β-, γ-, δ-, ξ-, η-, θ-, κ-, ρ- and χ-anhydrous alumina. The hydrated alumina is more preferred than the anhydrous alumina. Examples of the hydrated alumina include a monohydrated alumina and a trihydrate alumina. Examples of the monohydrated alumina include pseudo-boehmite, boehmite and diaspore. Examples of the trihydrated alumina include gibbsite and bayerite. The alumina is preferably porous.

The hydrated alumina can be synthesized by the sol-gel method in which ammonia is added to a solution of an aluminum salt to precipitate alumina or by a method of hydrolyzing an alkali aluminate. The anhydrous alumina can be obtained by heating to dehydrate a hydrated alumina.

The amount of the filler is preferably 5 parts to 2,000 parts by mass, relative to 100 parts by mass (in terms of dry mass) of the binder resin in the toner image-receiving layer.

The crosslinking agent may be incorporated in the resin composition of the toner image-receiving layer for controlling the shelf stability and thermoplasticity of the toner image-receiving layer. Examples of the crosslinking agent include a compound containing in the molecule two or more reactive groups selected from the group consisting of an epoxy group, an isocyanate group, an aldehyde group, an active halogen group, an active methylene group, an acetylene group and other conventional reactive groups.

Examples of the crosslinking agent include also a compound containing in the molecule two or more groups which can form a bond through a hydrogen bond, an ionic bond or a coordination bond.

Specific examples of the crosslinking agent include a compound which is conventional as a coupling agent, a curing agent, a polymerizing agent, a polymerization promoter, a coagulant, a film-forming agent or a film-forming assistant which are used for the resin. Examples of the coupling agent include chlorosilanes, vinylsilanes, epoxisilanes, aminosilanes, alkoxy aluminum chelates, titanate coupling agents and other conventional crosslinking agents described in the literature “Handbook of Rubber and Plastics Additives” (edited by Rubber Digest Co.).

The toner image-receiving layer preferably comprises a charge control agent for controlling the transfer and adhesion of the toner and for preventing the adhesion of the toner image-receiving layer due to the charge.

The charge control agent is not restricted and may be properly selected from conventional various charge control agents depending on the application. Examples of the charge control agent include a surfactant, such as a cationic surfactant, an anionic surfactant, an amphoteric surfactant and a non-ionic surfactant; a polymer electrolyte and a conductive metal oxide. Specific examples of the charge control agent include a cationic antistatic agent, such as a quaternary ammonium salt, a polyamine derivative, a cation-modified polymethyl methacrylate, a cation-modified polystyrene; an anionic antistatic agent, such as an alkyl phosphate and an anionic polymer; and a non-ionic antistatic agent, such as a fatty ester and a polyethylene oxide.

When the toner is negatively charged, the charge control agent in the toner image-receiving layer is preferably a cationic or nonionic charge control agent.

Examples of the conductive metal oxide include ZnO, TiO₂, SnO₂, Al₂O₃, In₂O₃, SiO₂, MgO, BaO and MoO₃. These conductive metal oxides may be used individually or in combination. The conductive metal oxide may contain (dope) another different element, for example, ZnO may contain (dope) Al and In; TiO₂ may contain (dope) Nb and Ta; and SnO₂ may contain (dope) Sb, Nb and a halogen element.

Other Additives

The toner image-receiving layer may comprise also various additives for improving the stability of the output image or the stability of the toner image-receiving layer itself. Examples of the additive include various conventional antioxidants, anti-aging agents, deterioration inhibitors, ozone-deterioration inhibitors, ultraviolet light absorbers, metal complexes, light stabilizers, antiseptic agents and anti-fungus agents.

The antioxidant is not restricted and may be properly selected depending on the application. Examples of the antioxidant include a chroman compound, a coumarin compound, a phenol compound (e.g., a hindered phenol), a hydroquinone derivative, a hindered amine derivative and a spiroindan compound. With respect to the antioxidant, there is a description in JP-A No. 61-159644.

The anti-aging agent is not restricted and may be properly selected depending on the application. Examples of the anti-aging agent include anti-aging agents described in the literature “Handbook of Rubber and Plastics Additives—Revised Second Edition” (published by Rubber Digest Co., 1993, pp. 76-121).

The ultraviolet light absorber is not restricted and may be properly selected depending on the application. Examples of the ultraviolet light absorber include a benzotriazol compound (see U.S. Pat. No. 3,533,794), a 4-thiazolidone compound (see U.S. Pat. No. 3,352,681), a benzophenone compound (see JP-A No. 46-2784) and an ultraviolet light absorbing polymer (see JP-A No. 62-260152).

The metal complex is not restricted and may be properly selected depending on the application. Proper examples of the metal complex include metal complexes described in patent documents, such as U.S. Pat. Nos. 4,241,155, 4,245,018, and 4,254,195; and JP-A Nos. 61-88256, 62-174741, 63-199248, 01-75568 and 01-74272.

Also, preferred examples of the ultraviolet light absorber or the light stabilizer include ultraviolet light absorbers or light stabilizers described in the literature “Handbook on Compounding Ingredients for Rubbers and Plastics, revised second edition” (published by Rubber Digest Co., 1993, pp. 122-137).

The toner image-receiving layer may optionally comprise the above-noted conventional additives for the photography. Examples of the additive for the photography include additives described in the literatures “Journal of Research Disclosure (hereinafter referred to as RD) No. 17643 (December, 1978), No. 18716 (November, 1979) and No. 307105 (November, 1989)”. These additives are specifically noted with respect to the pages of the Journal RD which are to be referred to a table as shown in the following Table 1.

TABLE 1

| | | Journal No. | | |
|---|---|---|---|---|
| Type of additives | | RD17643 | RD18716 | RD307105 |
| 1. | Whitening agent | pp. 24 | p. 648 | pp. 868 |
| | | | right column | |
| 2. | Stabilizer | pp. 24-25 | p. 649 | pp. 868-870 |
| | | | right column | |
| 3. | Light absorber | pp. 25-26 | p. 649 | pp. 873 |
| | (Ultraviolet light | | right column | |
| | absorber) | | | |
| 4. | Dye image | pp. 25 | p. 650 | pp. 872 |
| | stabilizer | | right column | |
| 5. | Film hardener | pp. 26 | p. 651 | pp. 874-875 |
| | | | left column | |
| 6. | Binder | pp. 26 | p. 651 | pp. 873-874 |
| | | | left column | |
| 7. | Plasticizer, | pp. 27 | p. 650 | pp. 876 |
| | lubricant | | right column | |
| 8. | Auxiliary coating | pp. 26-27 | p. 650 | pp. 875-876 |
| | agent (Surfactant) | | right column | |
| 9. | Antistatic agent | pp. 27 | p. 650 | pp. 876-877 |
| | | | right column | |
| 10. | Matting agent | — | — | pp. 878-879 |

The toner image-receiving layer is disposed on the support by coating the support with the coating liquid containing a thermoplastic resin used for producing the toner image-receiving layer using a wire coater and by drying the resultant coating. The Minimum Film Forming Temperature (MFT) of the thermoplastic resin used in the present invention is preferably room temperature or higher during the storage of the image-receiving sheet before the printing and preferably 100° C. or lower during the fixing of the toner particles.

The mass of the dried coating as the toner image-receiving layer is preferably from 1 g/m² to 20 g/m², more preferably from 4 g/m² to 15 g/m².

The thickness of the toner image-receiving layer is not restricted and may be properly selected depending on the application. The thickness is preferably ½ or more of the diameter of the toner particles, more preferably from 1 time to 3 times the diameter of the toner particles. More specifically, the thickness is preferably from 1 μm to 50 μm, more preferably from 1 μm to 30 μm, still more preferably from 2 μm to 20 μm, most preferably from 5 μm to 15 μm.

[Physical Properties of Toner Image-Receiving Layer]

The 180-degree peel strength of the toner image-receiving layer at the temperature for the image-fixing at which the image is fixed on the fixing member is preferably 0.1 N/25 mm or less, more preferably 0.041 N/25 mm or less. The 180-degree peel strength can be measured according to the method described in JIS K 6887 using a surface material of the fixing member.

It is preferred that the toner image-receiving layer has the whiteness of a high degree. The whiteness is measured by the method described in JIS P 8123 and is preferably 85% or more. It is preferred that the spectral reflectance of the toner image-receiving layer is 85% or more in the wavelength range of from 440 nm to 640 nm and the difference between the maximum spectral reflectance of the toner image-receiving layer and the minimum spectral reflectance of the toner image-receiving layer in the above-noted wavelength range is within 5%. Further, it is more preferred that the spectral reflectance of the toner image-receiving layer is 85% or more in the wavelength range of from 400 to 700 nm and the difference between the maximum spectral reflectance of the toner image-receiving layer and the minimum spectral reflectance of the toner image-receiving layer in the above-noted wavelength range is within 5%.

With respect to the whiteness of the toner image-receiving layer, specifically, in the CIE 1976 (L* a* b*) color space, an L* value is preferably 80 or more, more preferably 85 or more, still more preferably 90 or more. The tone of the whiteness is preferably as neutral as possible and more specifically, with respect to the tone of the whiteness of the toner image-receiving layer, in the (L* a* b*) space, the value of (a*)²+(b*)² is preferably 50 or less, more preferably 18 or less, still more preferably 5 or less.

It is preferred that the toner image-receiving layer has high glossiness after the image-forming. With respect to the gloss level of the toner image-receiving layer, through the range of from the state in which the toner image-receiving layer is white (i.e., there is no toner in the toner image-receiving layer) to the state in which the toner image-receiving layer is black (i.e., there is full of the toner in the toner image-receiving layer), the 45-degree gloss level of the toner image-receiving layer is preferably 60 or more, more preferably 75 or more, still more preferably 90 or more.

However, the gloss level of the toner image-receiving layer is preferably 110 or less. When the gloss level is more than 110, the image has a metallic luster and such a quality of the image is undesirable.

The gloss level can be measured according to JIS Z 8741.

It is preferred that the toner image-receiving layer has high smoothness after the fixing. With respect to the smoothness of the toner image-receiving layer, through the range of from the state in which the toner image-receiving layer is white (i.e., there is no toner in the toner image-receiving layer) to the state in which the toner image-receiving layer is black (i.e., there is full of the toner in the toner image-receiving layer), the arithmetic average roughness (Ra) of the toner image-receiving layer is preferably 3 μm or less, more preferably 1 μm or less, still more preferably 0.5 μm or less.

The arithmetic average roughness can be measured, for example, according to the methods described in JIS B 0601, B 0651 and B 0652.

The toner image-receiving layer has preferably one of the physical properties described in the following items (1) to (6), more preferably several of them, most preferably all of them.
(1) The melt temperature (Tₘ) of the toner image-receiving layer is preferably 30° C. or higher, more preferably a temperature which is higher than Tₘ of the toner by 20° C., or lower.
(2) The temperature at which the viscosity of the toner image-receiving layer is 1×10⁵ cp is preferably 40° C. or higher, more preferably a temperature which is is lower than the temperature at which the viscosity of the toner is 1×10⁵ Cp.
(3) The storage elasticity modulus (G′) of the toner image-receiving layer at the temperature for the image-fixing is preferably from 1×10² Pa to 1×10⁵ Pa and the loss elasticity modulus (G″) of the toner image-receiving layer at the temperature for the image-fixing is preferably from 1×10² Pa to 1×10⁵ Pa.
(4) The loss tangent (G″/G′) of the toner image-receiving layer is preferably from 0.01 to 10, wherein the loss tangent is the ratio of the loss elasticity modulus (G″) to the storage elasticity modulus (G′).
(5) The storage elasticity modulus (G′) of the toner image-receiving layer at the fixing temperature differs from the storage elasticity modulus (G′) of the toner at the fixing temperature, preferably by −50 to +2500.
(6) The inclination angle of the molten toner on the toner image-receiving layer is preferably 50° or less, more preferably 40° or less.

The toner image-receiving layer preferably satisfies the physical properties described in Japanese Patent No. 2788358 and JP-A Nos. 07-248637, 08-305067 and 10-239889.

The surface electrical resistance of the toner image-receiving layer is preferably in the range of from 1×10⁶ Ω/cm² to 1×10¹⁵ Ω/cm² (under conditions of 25° C. and 65% RH).

When the surface electrical resistance is less than 1×10⁶ Ω/cm², the amount of the toner transferred to the toner image-receiving layer is unsatisfactory, so that a disadvantage is caused wherein the density of the obtained toner image becomes easily too low. On the other hand, when the surface electrical resistance is more than 1×10¹⁵ Ω/cm², more charge than the necessity is generated in the toner image-receiving layer during the transfer, so that disadvantages are caused wherein the toner is transferred so unsatisfactorily that the density of the obtained image is low and the electrophotographic image-receiving label sheet is electrostatically charged, so that the image-receiving sheet adsorbs easily the dust. Moreover, in this case, miss field, multi feed, discharge marks and toner transfer dropout may occur during the copying.

The surface electrical resistance of the toner image-receiving layer can be measured according to the method described in JIS K 6911 as follows. The sample of the toner image-receiving layer is left under the condition where the temperature is 20° C. and the humidity is 65% for 8 hours or more and after applying a voltage of 100 V to the sample of the toner image-receiving layer for 1 minute under the same condition as the above-noted condition, the surface electrical resistance of the toner image-receiving layer can be measured using a micro-ammeter R8340 (manufactured and sold by Advantest Ltd.).

[Other Layers]

Examples of the other layers which the image-receiving sheet for the electrophotography comprises include a back layer, a surface-protecting layer, an adhesion-improving layer, an intermediate layer, an undercoating layer, a cushion layer, a charge-controlling (preventing) layer, a reflective layer, a tint-controlling layer, a shelf stability-improving layer, an anti-adhesion layer, an anti-curling layer and a smoothing layer. These layers may be in a single layer structure or a laminated structure of plural layers.

Back Layer

The back layer in the image-receiving sheet the electrophotography according to the present invention is preferably disposed on a surface of the support, which is opposite to another surface of the support on which the toner image-receiving layer is disposed, for imparting back side-output suitability to the image-receiving sheet and improving the image quality of the back side-output, curling balance and conveyability of the image-receiving sheet.

The color of the back layer is not restricted and may be properly selected depending on the application. When the image-receiving sheet for the electrophotography according to the present invention is an image-receiving sheet of the both-side output type forming the image also on the back side, however, also the color of the back layer is preferably white. The back layer has preferably whiteness of 85% or more and spectral reflectance of 85% or more, like the image-receiving layer.

Moreover, for improving both-side output suitability, the back layer may have a composition same as that of the front side of the sheet, which comprises the toner image-receiving layer. The back layer may comprise besides the above-noted particles, the above-explained various additives. It is appropriate that as the additives, particularly a charge control agent is used. The back layer may have a single-layer structure or a laminated structure of two or more layers.

When for preventing the offset during the image-fixing, an oil having release properties is applied to the fixing roller, the back layer may have oil absorbency.

Usually, the thickness of the back layer is preferably 0.1 to 10 μm.

Surface Protective Layer

The surface protective layer may be disposed on the surface of the toner image-receiving layer for protecting the surface of the image-receiving sheet for the electrophotography according to the present invention, improving shelf stability, handling properties and conveyability thereof, and imparting writing properties and anti-offset properties thereto. The surface protective layer may have a single-layer structure or a laminated structure of two or more layers. The surface protective layer may comprise as a binder resin at least one of various thermoplastic resins and thermosetting resins which is preferably a resin of the same type as that of a resin used for the toner image-receiving layer. In this case, however, a resin used for the surface protective layer needs not to have the same thermodynamic properties or electrostatic properties as that of a resin used for the toner image-receiving layer and those properties of the surface protective layer can be respectively optimized.

The surface protective layer may comprise the above-noted various additives which can be used for producing the toner image-receiving layer. Particularly, the surface protective layer may comprise together with the above-noted releasing agent used in the present invention, other additives, such as a matting agent. Examples of the matting agent include various conventional matting agents.

The most outer surface layer of the image-receiving sheet for the electrophotography (e.g., the surface protective layer when it is disposed) has preferably good compatibility with the toner from the viewpoint of good fixability of the toner image. More specifically, the most outer surface layer has preferably a contact angle with the molten toner of from 0° to 40°.

Adhesion-Improving Layer

The adhesion-improving layer in the image-receiving sheet for the electrophotography according to the present invention is disposed preferably for improving adhesion between the support and the toner image-receiving layer. The adhesion-improving layer may comprise the above-noted various additives, particularly preferably the crosslinker. Further, it is preferred that in the image-receiving sheet for the electrophotography according to the present invention, for improving the toner receptivity, a cushion layer is disposed between the adhesion improving layer and the image-receiving layer.

Intermediate Layer

The intermediate layer may be, for example, between the support and the adhesion-improving layer, between the adhesion-improving layer and the cushion layer, between the cushion layer and the toner image-receiving layer, or between the toner image-receiving layer and the shelf stability improving layer. When the image-receiving sheet for the electrophotography comprises the support, the toner image-receiving layer and the intermediate layer, the intermediate layer may be disposed, for example, between the support and the toner image-receiving layer.

The thickness of the image-receiving sheet for the electrophotography according to the present invention is not restricted and may be properly selected depending on the application. The thickness is preferably from 50 μm to 500 μm, more preferably from 100 μm to 350 μm.

<Toner>

The image-receiving sheet for the electrophotography according to the present invention is used by causing the toner image-receiving layer to receive the toner during the printing and copying.

The toner comprises at least a binder resin and a colorant, and optionally a releasing agent and other components.

Binder Resin for Toner

The binder resin is not restricted and may be selected from resins used usually for producing the toner depending on the application. Examples of the binder resin include homo-polymers or copolymers produced by polymerizing or copolymerizing a vinyl monomer or two or more vinyl monomers selected from the group consisting of vinyl monomers, such as styrenes, such as styrene and parachlorostyrene; vinyl esters, such as vinyl naphthalene, vinyl chloride, vinyl bromide, vinyl fluoride, vinyl acetate, vinyl propioniate, vinyl benzoate and vinyl butyrate; methylene fatty carboxylate esters, such as methyl acrylate, ethyl acrylate, n-butyl acrylate, isobutyl acrylate, dodecyl acrylate, n-octyl acrylate, 2-chloroethyl acrylate, phenyl acrylate, methyl α-chloroacrylate, methyl methacrylate, ethyl methacrylate and butyl methacrylate; vinyl nitrites, such as acrylonitrile, methacrylonitrile and acrylamide; vinyl ethers, such as vinyl methyl ether, vinyl ethyl ether and vinyl isobutyl ether; N-vinyl compounds, such as N-vinyl pyrrole, N-vinyl carbazole, N-vinyl indole and N-vinyl pyrrolidone; and vinyl carboxylic acids, such as methacrylic acid, acrylic acid and cinnamic acid. Examples of the binder resin include also various polyesters. The above-noted examples of the binder resin may be used in combination with various waxes.

Among these resins, a resin of the same type as that of the resin used for producing the toner image-receiving layer according to the present invention is preferably used.

Colorant for Toner

The colorant used for the toner is not restricted and may be properly selected from colorants used usually for producing the toner depending on the application. Examples of the colorant include various pigments, such as carbon black, chrome yellow, hansa yellow, benzidine yellow, threne yellow, quinoline yellow, Permanent Orange GTR, Pyrazolone orange, vulcan orange, watchung red, permanent red, Brilliant Carmine 3B, Brilliant Carmine 6B, Du Pont Oil Red, Pyrazolone Red, Lithol Red, Rhodamine B lake, Lake Red C, Rose Bengal, aniline blue, ultra marine blue, chalco oil blue, methylene blue chloride, phthalocyanine blue, phthalocyanine green, malachite green oxalate; and various dyes, such as acridine dyes, xanthene dyes, azo dyes, benzoquinone dyes, azine dyes, anthraquinone dyes, indigo dyes, thioindigo dyes, dioxazine dyes, thiazine dyes, azomethine dyes, phthalocyanine dyes, aniline black dyes, polymethine dyes, triphenylmethane dyes, diphenylmethane dyes and thiazole dyes.

These colorants may be used individually or in combination.

The amount of the colorant is not restricted and may be properly selected depending on the application. The amount is preferably from 2% to 8% by mass, based on the mass of the toner. When the amount of the colorant is less than 2% by mass, the coloring power of the toner may be weakened. On the other hand, when the amount is more than 8% by mass, the clarity of the toner may be impaired.

Releasing Agent for Toner

The releasing agent used for the toner is not restricted and may be properly selected from releasing agents used usually for the toner depending on the application. Particularly effective examples of the releasing agent include a highly crystalline polyethylene wax having a relatively low molecular weight, a Fischer-Tropsch wax, amide wax and a polar wax containing nitrogen, such as a compound having a urethane bond.

The polyethylene wax has a molecular weight of preferably 1000 or less, more preferable from 300 to 1000.

The compound having a urethane bond is preferred in that even if the compound has a low molecular weight, the compound can maintain a solid state by a strong cohesive force of a polar group and such a compound having a high melting point for the molecular weight thereof can be produced. The compound has a molecular weight of preferably from 300 to 1000. Examples of a combination of materials for producing the compound having a urethane bond include a combination of a diisocyanic acid compound and a monohydric alcohol, a combination of a monoisocyanic acid compound and a monohydric alcohol, a combination of a dihydric alcohol and a monoisocyanic acid compound, a combination of a trihydric alcohol and a monoisocyanic acid compound and a combination of a triisocyanic acid compound and a monohydric alcohol. However, for preventing the molecular weight of the compound from becoming too large, a combination of a compound having a multiple functional group and another compound having a single functional group is preferred and it is important that the total amount of the functionality in a combination is always equivalent.

Examples of the monoisocyanic acid compound include dodecyl isocyanate, phenyl isocyanate (and derivatives thereof), naphthyl isocyanate, hexyl isocyanate, benzyl isocyanate, butyl isocyanate and allyl isocyanate.

Examples of the diisocyanic acid compound include tolylene diisocyanate, 4,4′ diphenylmethane diisocyanate, toluene diisocyanate, 1,3-phenylene diisocyanate, hexamethylene diisocyanate, 4-methyl-m-phenylene diisocyanate and isophorone diisocyanate.

Examples of the monohydric alcohol include methanol, ethanol, propanol, butanol, pentanol, hexanol and heptanol.

Examples of the dihydric alcohol include various glycols, such as ethylene glycol, diethylene glycol, triethylene glycol and trimethylene glycol.

Examples of the trihydric alcohol include trimethylol propane, triethylol propane and trimethanol ethane.

These urethane compounds may be mixed with a resin or a colorant during the kneading like a usual releasing agent to be used as a kneaded-ground type toner. When these urethane compounds are used for producing the toner produced according to the emulsion polymerization-cohesion and melting method, an aqueous dispersion of the releasing agent particles having a size of 1 μm or less is prepared according to a method comprising dispersing in water the urethane compound together with an ionic surfactant and a polymeric electrolyte, such as a polymeric acid and a polymeric base, thereby obtaining a dispersion of a releasing agent, heating the obtained dispersion to the melting point of the urethane compound or higher, and grinding the urethane compound until the urethane compound becomes in the form of fine particles by subjecting the above-noted dispersion to a strong shearing using a homogenizer or a dispersing apparatus of a pressure discharge type, and the prepared dispersion of fine particles of the releasing agent is used in combination with a dispersion of resin particles and a dispersion of colorant particles to produce the toner produced according to the emulsion polymerization-cohesive melting method.

Other Components for Toner

The toner may comprise other components, such as an inner additive, a charge control agent and inorganic fine particles. Examples of the inner additive include a magnetic material, such as a metal, such as ferrite, magnetite, reduced iron, cobalt, nickel and manganese; an alloy thereof; and a compound containing these metals.

Examples of the charge control agent include various charge control agents used usually, such as a quaternary ammonium salt, a nigrosine compound, a dye comprising a complex of a metal (, such as aluminum, iron and chromium) and a triphenylmethane pigment. It is preferred that the charge control agent is difficultly dissolved in water, from the view point of suppressing the ion strength in the toner, which may affect the stability of the charge control agent during the cohesion and the melting and reducing the pollution by the waste water.

Examples of the inorganic fine particles include all usual outer additives of the toner surface, such as silica, alumina, titania, calcium carbonate, magnesium carbonate and tricalcium phosphate. These particles are preferably used in the form of a dispersion produced by dispersing the particles in an ionic surfactant, a polymer acid or a polymer base.

Further, the toner may comprise as an additive a surfactant for the emulsion polymerization, the seed emulsion polymerization, the pigment dispersion, the resin particles dispersion, the releasing agent dispersion, the cohesion and stabilization thereof. Examples of the surfactant include an anionic surfactant, such as a sulfate ester surfactant, a sulfonate ester surfactant, a phosphate ester surfactant and a soap; a cationic surfactant, such as an amine salt surfactant and a quaternary ammonium salt surfactant. It is also effective the above-exemplified surfactants are used in combination with a nonionic surfactant, such as a polyethylene glycol surfactant, an alkylphenol ethylene oxide adduct surfactant and a polyhydric alcohol surfactant. As a dispersing unit for dispersing the surfactant in the toner, a general unit, such as a rotary shearing type homogenizer; and a ball mill, a sand mill and a dyno mill, all of which contain the media can be used.

The toner may comprise optionally an outer additive. Examples of the outer additive include inorganic particles and organic particles. Examples of the inorganic particles include particles of SiO₂, TiO₂, Al₂O₃, CuO, ZnO, SnO₂, Fe₂O₃, MgO, BaO, CaO, K₂O, Na₂O, ZrO₂, CaO.SiO₂, K₂O.(TiO₂)ₙ, Al₂O₃.2SiO₂, CaCO₃, MgCO₃, BaSO₄ and MgSO₄. Examples of the organic particles include particles of an fatty acid and derivatives thereof; a metal salt of the above-noted fatty acid and derivatives thereof; and a resin, such as a fluorine resin, a polyethylene resin and an acrylic resin.

The average particle diameter of the above-noted particles is preferably from 0.01 μm to 5 μm, more preferably from 0.1 μm to 2 μm.

The manufacturing method of the toner is not restricted and may be properly selected depending on the application. However, it is preferred that the toner is produced according to a manufacturing method of the toner comprising (i) preparing a dispersion of cohesive particles of a resin by forming cohesive particles in a dispersion of resin particles, (ii) forming attached particles by mixing the above-prepared dispersion of cohesive particles with a dispersion of fine particles, so that the fine particles attaches to the cohesive particles, thereby forming attached particles and (iii) forming toner particles by heating the attached particles to melt the attached particles.

Physical Properties of Toner

The toner according to the present invention has a volume average particle diameter of preferably from 0.5 μm to 10 μm. When the volume average particle diameter of the toner is too small, handling properties of the toner (, such as replenish properties, cleaning properties and fluidity) may be affected adversely and the productivity of the particles may be lowered. On the other hand, when the volume average particle diameter of the toner is too large, the quality and resolution of the image due to graininess and transferability may be affected adversely.

It is preferred that the toner according to the present invention satisfies the above-noted range of a volume average particle diameter and has a distribution index of the volume average particle diameter (GSDv) of 1.3 or less.

The ratio (GSDv/GSDn) of the distribution index of the volume average particle diameter (GSDv) to the distribution index of the number average particle diameter (GSDn) is preferably 0.95 or more.

It is preferred that the toner according to the present invention satisfies the above-noted range of the volume average particle diameter and has an average (1.00 to 1.50) of the shape factor calculated according to the following equation:
Shape factor=(λ×L²)/(4×S)
wherein L represents the maximum length of the toner particles and S represents the projected area of the toner particles.

When the toner satisfies the above-noted conditions, an effect on the image quality, such as graininess and resolution particularly can be obtained and moreover, dropout or blur which may accompany with the transfer is difficultly caused. Further, in this case, the handling properties of the toner may be difficultly affected adversely, even if the average particle diameter of the toner is not small.

From the viewpoint of improving the image quality and preventing the offset during the image-fixing, it is appropriate that the toner has storage elasticity modulus G′ (as measured at a circular frequency of 10 rad/sec) of 1×10² Pa to 1×10⁵ Pa at 150° C.

(Image-Forming Process)

The image-forming process according to the present invention comprises forming the toner image and fixing the image by smoothing the image surface, and optionally other steps.

Forming Toner Image

The forming of the toner image is performed by forming the toner image in the toner image-receiving sheet for the electrophotography according to the present invention.

The forming of the toner image is not restricted so long as by the forming, the toner image can be formed in the image-receiving sheet for the electrophotography and may be properly selected depending on the application. Examples of the forming of the toner image include a usual method used for the electrophotography, such as a direct transfer method in which the toner image formed on the developing roller is directly transferred to the image-receiving sheet for the electrophotography and an intermediate transfer belt method in which the toner image formed on the developing roller is primary-transferred to the intermediate transfer belt and the primary-transferred image is transferred to the image-receiving sheet for the electrophotography. Among them, from the viewpoint of environmental stability and enhancing the image quality, the intermediate transfer belt method is preferably used.

Fixing the Image by Smoothing the Image Surface

The fixing of the toner image by smoothing the surface of the toner image is performed by heating, pressing and cooling the toner image and by peeling the image-receiving sheet from the belt using an apparatus configured to fix the toner image by smoothing the surface of the image which is equipped with a heating-pressing unit, a belt and a cooling unit.

The apparatus configured to fix the image by smoothing the image surface comprises a heating-pressing unit, a belt, a cooling unit, a cooling-peeling portion and optionally other units.

The heating-pressing unit is not restricted and may be properly selected depending on the application. Examples of the heating-pressing unit include a pair of heating rollers and a combination of a heating roller and a pressing roller.

The cooling unit is not restricted and may be properly selected depending on the application. Examples of the cooling unit include a cooling unit which can blow a cool air and can control the cooling temperature, and a heat sink.

The cooling-peeling portion is not restricted and may be properly selected depending on the application. Examples of the cooling-peeling portion include a section which is near of the tension roller where the image-receiving sheet for the electrophotography is peeled from the belt by own stiffness (nerve) of the image-receiving sheet.

For contacting the toner image with a heating-pressing unit of the apparatus configured to fixing the image by smoothing the image surface, the image-receiving sheet is preferably pressed. The method for pressing the image-receiving sheet is not restricted and may be properly selected depending on the application; however, a nip pressure is preferably used. The nip pressure is, from the viewpoint of forming an image which is excellent in water resistance and surface smoothness and has excellent gloss, preferably from 1 kgf/cm² to 100 kgf/cm², more preferably from 5 kgf/cm² to 30 kgf/cm². The heating temperature in the heating-pressing unit is a temperature which is higher than the softening point of the polymer used for the toner image-receiving layer and is varied depending on the type of the polymer used for the toner image-receiving layer, however is usually preferably from 80° C. to 200° C. The cooling temperature in the cooling unit is preferably a temperature which is 80° C. or less at which the polymer layer as the toner image-receiving layer is satisfactorily set, more preferably from 20° C. to 80° C.

The belt comprises a heat-resistant support film and a mold-releasing layer disposed on the support film.

The material for the support film is not restricted so long as the material has heat resistance and may be properly selected depending on the application.

Examples of the material include polyimide (PI), polyethylene naphthalate (PEN), polyethylene terephthalate (PET), polyether ether ether ketone (PEEK), polyether sulfone (PES), poly ether imide (PEI) and poly parabanic acid (PPA).

The mold-releasing layer comprises preferably at least one selected from the group consisting of a silicone rubber, a fluorine rubber, a fluorocarbon siloxane rubber, a silicone resin and a fluorine resin. Among them, the following aspects i) and ii):
i) a fluorocarbon siloxane rubber layer disposed on the surface of the belt and ii) a silicone rubber layer disposed on the surface of the belt and a fluorocarbon siloxane rubber layer disposed on the surface of the silicone rubber layer, are preferred.

The fluorocarbon siloxane rubber in the fluorocarbon siloxane rubber layer has preferably in the backbone chain thereof at least one of a perfluoroalkyl ether group and a perfluoroalkyl group.

The fluorocarbon siloxane rubber is preferably a cured form of a fluorocarbon siloxane rubber composition comprising the following components (A)-(D):
(A) a fluorocarbon polymer comprising mainly a fluorocarbon siloxane represented by the following formula (1) and having an unsaturated fatty hydrocarbon group, (B) at least one of organopolysiloxane and fluorocarbon siloxane which have two or more ≡SiH groups in the molecule, wherein the amount of a ≡SiH group is from one to four times (in mole) the amount of the unsaturated fatty hydrocarbon group in the above-noted fluorocarbon siloxane rubber composition, (C) a filler, and (D) an effective amount of catalyst.

The fluorocarbon polymer as the component (A) comprises mainly a fluorocarbon siloxane containing a recurring unit represented by the following formula (1) and contains an unsaturated fatty hydrocarbon group.

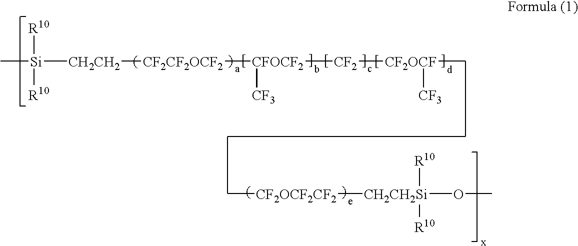

In formula (1), R¹⁰ represents an unsubstituted or substituted C₁-C₈ monovalent hydrocarbon group and is preferably a C₁-C₈ alkyl group or a C₂-C₃ alkenyl group, most preferably a methyl group. a and e are respectively an integer of 0 or 1, b and d are respectively an integer of 1 to 4 and c is an integer of 0 to 8. x is preferably an integer of 1 or more, more preferably an integer of 10 to 30.

Examples of the component (A) include a compound represented by the following formula (2):

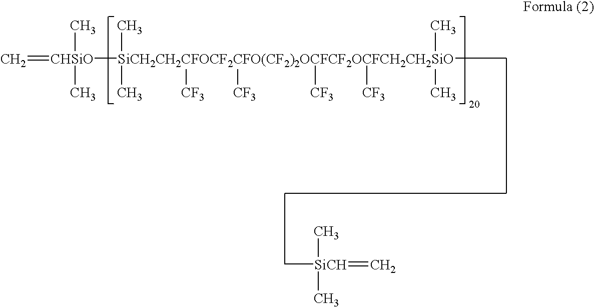

With respect to the component (B), examples of the organopolysiloxane having ≡SiH groups include an organohydrogen polysiloxane having in the molecule at least two hydrogen atoms bonded to a silicon atom.

In the fluorocarbon siloxane rubber composition, when the fluorocarbon polymer as the component (A) has an unsaturated fatty hydrocarbon group, as a curing agent, the above-noted organohydrogen polysiloxane is preferably used. In other words, the cured form is produced by an addition reaction between the unsaturated fatty hydrocarbon group of the fluorocarbon siloxane and a hydrogen atom bonded to a silicon atom in the organohydrogen polysiloxane.

Examples of the organohydrogen polysiloxane include various organohydrogen polysiloxanes used for curing a silicone rubber composition which is cured by an addition reaction.

The amount of the organohydrogen polysiloxane is an amount by which the number of ≡SiH groups in the organohydrogen polysiloxane is preferably at least one, most preferably from 1 to 5, relative to one unsaturated fatty hydrocarbon group in the fluorocarbon siloxane of the component (A).

Also, with respect to the component (B), preferred examples of the fluorocarbon siloxane having the ≡SiH groups include a fluorocarbon siloxane having a structure of the recurring unit represented by the formula (1), and a fluorocarbon siloxane having a structure of the recurring unit represented by the formula (1) in which R¹⁰ is a dialkylhydrogen siloxy group and the terminal group is a ≡SiH group, such as a dialkylhydrogen siloxy group or a silyl group. Such a preferred fluorocarbon siloxane can be represented by the following formula (3).

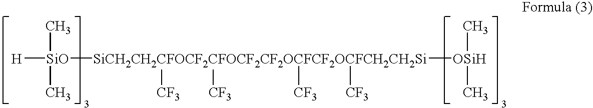

As the filler which is the component (C), various fillers used for a usual silicone rubber composition can be used. Examples of the filler include a reinforcing filler, such as a mist silica, a precipitated silica, a carbon powder, titanium dioxide, aluminum oxide, a quartz powder, talc, sericite and bentonite; and a fiber filler, such as an asbesto, a glass fiber, and an organic fiber.

Examples of the catalyst as the component (D) include an element belonging to Group VIII in the Periodic Table and a compound thereof, such as chloroplatinic acid; alcohol-modified chloroplatinic acid; a complex of chloroplatinic acid with an olefin; platinum black and palladium which are respectively supported on a carrier, such as alumina, silica and carbon; a complex of rhodium with an olefin, chlorotris(triphenylphosphine)rhodium (Wilkinson catalyst) and rhodium (III) acetyl acetonate, which are conventional catalysts for the addition reaction. It is preferred that these complexes are dissolved in a solvent, such as an alcohol compound, an ether compound or a hydrocarbon compound to be used.

The fluorocarbon siloxane rubber composition is not restricted and may be properly selected depending on the application, and optionally may comprise various additives. Examples of the various additives include a dispersing agent, such as a diphenylsilane diol, a low polymer of dimethyl polysiloxane in which the terminal of the molecule chain is blocked with a hydroxyl group, and a hexamethyl disilazane; a heat resistance improver, such as ferrous oxide, ferric oxide, cerium oxide and iron octylate; and a colorant, such as a pigment.

The belt can be obtained by coating a heat-resistant support film with the fluorocarbon siloxane rubber composition and by curing the resultant coated support film by the heating. Further optionally, the belt can be obtained by coating the support film with a coating liquid prepared by diluting the fluorocarbon siloxane rubber composition with a solvent, such as m-xylene hexafluoride and benzotrifluoride, according to a general coating method, such as spray coating, dip coating and knife coating. The heating-curing temperature and time may be properly selected from the ranges of from 100° C. to 500° C. (temperature) and from 5 seconds to 5 hours (time) depending on the type of the support film and the manufacturing method of the belt.

The thickness of the mold-releasing layer disposed on the surface of the heat-resistant support film is not restricted and may be properly selected depending on the application. For obtaining an advantageous fixing properties of the image by suppressing the release characteristics of the toner or by preventing the off-set of the toner component, the thickness is preferably from 1 μm to 200 μm, more preferably from 5 μm to 150 μm.

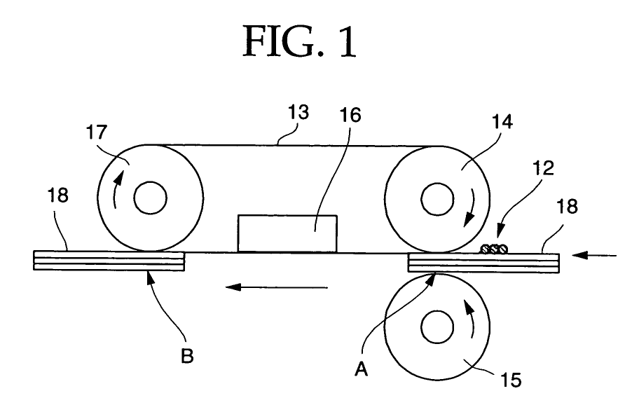

Here, with respect to an example of the apparatus configured to fix the image by smoothing the image surface, which is equipped with a typical fixing belt and is used in the process for forming the image according to the present invention, explanations are given in detail with referring to FIG. 1.

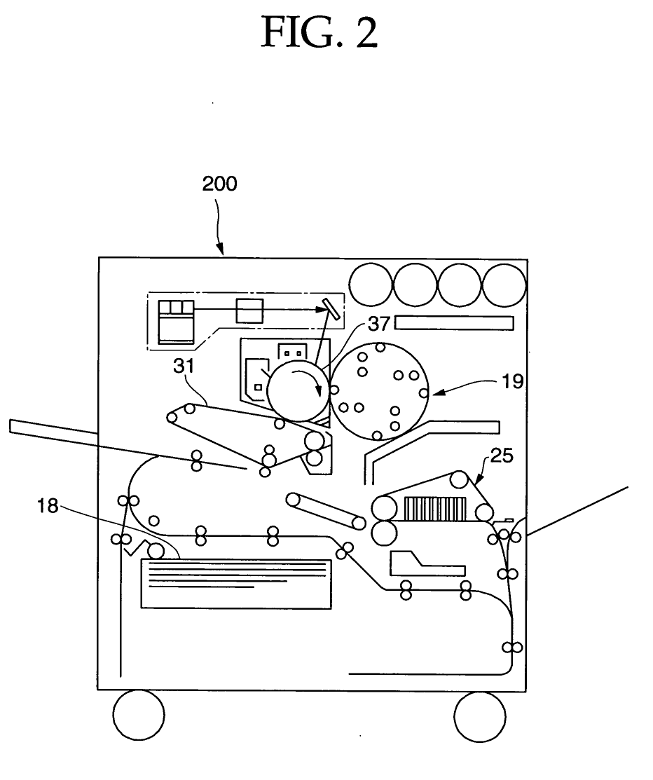

First, by an image-forming apparatus (not illustrated in FIG. 2), the toner 12 is transferred to the image-receiving sheet for the electrophotography 1. The image-receiving sheet 1 to which the toner 12 is adhered is conveyed to the point A by a conveying unit (not illustrated in FIG. 1) and passes through between the heating roller 14 and the pressing roller 15 to be heated and pressed at the temperature (fixing temperature) and under the pressure, wherein the temperature and pressure are enough high to soften satisfactorily the toner image-receiving layer of the image-receiving sheet 1 and the toner 12.

Here, the fixing temperature means a temperature of the surface of the toner image-receiving layer measured in a nip space between the heating roller 14 and the pressing roller 15 at the point A and is preferably from 80° C. to 190° C., more preferably from 100° C. to 170° C. The (fixing) pressure means a pressure of the surface of the toner image-receiving layer measured also in a nip space between the heating roller 14 and the pressing roller 15 at the point A and is preferably from 1 kgf/cm² to 10 kgf/cm², more preferably from 2 kgf/cm² to 7 kgf/cm².

The image-receiving sheet 11 which is thus heated and pressured is, next, conveyed by the fixing belt 13 to the cooling unit 16 and during the conveying of the image-receiving sheet 1, in the image-receiving sheet 1, a mold-releasing agent (not illustrated in FIG. 1) dispersed in the toner image-receiving layer is satisfactorily heated and molten. The molten mold-releasing agent is gathered to the surface of the toner image-receiving layer, so that in the surface of the toner image-receiving layer, a layer (film) of the mold-releasing agent is formed. The image-receiving sheet 1 conveyed to the cooling unit 16 is cooled by the cooling unit 16 to a temperature which is, for example, not higher than either the softening point of a binder resin used for producing the toner image-receiving layer or the toner, or the temperature which is higher than the glass transition point of the above-noted binder resin by 10° C., wherein the temperature to which the image-receiving sheet 1 is cooled is preferably from 20° C. to 80° C., more preferably room temperature (25° C.). Thus, the layer (film) of the mold-releasing agent formed in the surface of the toner image-receiving layer is cooled and set, thereby forming the mold-release agent layer.

The cooled image-receiving sheet 1 is conveyed by the fixing belt 13 further to the point B and the fixing belt 13 moves along the tension roller 17. Accordingly, at the point B, the image-receiving sheet 1 is peeled from the fixing belt 13. It is preferred that the diameter of the tension roller 17 is so small designed that the image-receiving sheet 1 can be peeled from the fixing belt 13 by own stiffness (nerve) of the image-receiving sheet 1.

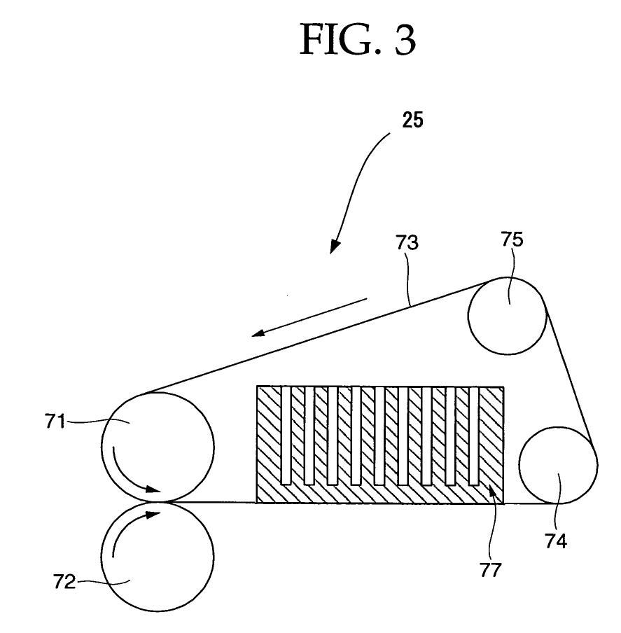

An apparatus configured to fix the image by smoothing the image surface shown in FIG. 3 can be used in an image-forming apparatus (e.g., a full-color laser printer DCC-500 (manufactured and sold by Fuji Xerox Co., Ltd.)) shown in FIG. 2 by converting the image-forming apparatus to a part of the belt fixing in the image-forming apparatus.

As shown in FIG. 2, the image-forming apparatus 200 includes photoconductive drum 37, development device 19, intermediate transfer belt 31, the image-receiving sheet for the electrophotography 18, and the apparatus configured to fix the image by smoothing the image surface 25.

FIG. 3 shows the apparatus configured to fix the image by smoothing the image surface 25 which can be converted to the belt fixing part of the image-forming apparatus 200 in FIG. 2.

As shown in FIG. 3, the apparatus configured to fix the image by smoothing the image surface 25 comprises heat roller 71, peeling roller 74, tension roller 75, endless belt 73 supported rotatably by the tension roller 75 and pressure roller 72 contacted by pressure to the heat roller 71 through the endless belt 73.

Cooling heatsink 77 which forces the endless belt 73 to cool is arranged inside the endless belt 73 between the heat roller 71 and the peeling roller 74. The cooling heatsink 77 constitutes the cooling and sheet-conveying unit for cooling and conveying the image-receiving sheet for the electrophotography 18.

In the apparatus configured to fix the image by smoothing the image surface 25 as shown in FIG. 3, the image-receiving sheet for the electrophotography bearing a color toner image transferred and fixed on the surface of the image-receiving sheet, is so introduced into a press-contacting portion (or nip portion) between the heat roll 71 and the pressure roll 72 contacted by pressure to the heat roller 71 through the endless belt 73 that the color toner image in the image-receiving sheet faces to the heat roller 71, wherein while the image-receiving sheet passes through the press-contacting portion between the heat roller 71 and the pressure roller 72, the color toner image is heated and fused to be fixed on the image-receiving sheet for the electrophotography.

Thereafter, the image-receiving sheet for the electrophotography bearing the color toner image fixed in the image-receiving layer of the image-receiving sheet by heating the toner of the color toner image to a temperature of substantially from 120 to 130° C. at the press-contacting portion between the heat roller 71 and the pressure roller 72 is conveyed by the endless belt 73, while the toner image-receiving layer in the surface of the image-receiving label sheet is adhered to the surface of the endless belt 73. During the conveying of the image-receiving sheet, the endless belt 73 is forcedly cooled by the cooling heatsink 77 and the color toner image and the image-receiving layer are cooled and set, so that the image-receiving sheet for the electrophotography is peeled from the endless belt 73 by the peeling roller 74 and own stiffness (nerve) of the image-receiving sheet.

The surface of the endless belt 73 after the peeling of the image-receiving sheet is cleaned by removing a residual toner therefrom using a cleaner (not illustrated in FIG. 3) and prepared for the next fixing of the image by smoothing the image surface.

According to the image-forming process according to the present invention, even if by using an image-forming apparatus equipped with no fixing oil, not only the release characteristics of the image-receiving sheet for the electrophotography and the toner can be suppressed or the off-set of the image-receiving sheet for the electrophotography and the toner components can be prevented, so that a stable feeding of the image-receiving sheet can be obtained, but also an image which is excellent in anti-crazing due to humidity change properties, anti-adhesion properties, anti-crazing properties and gloss level, and has a similar high image-quality to a print of a silver salt photography can be formed.

Hereinbelow, with referring to Examples and Comparative Examples, the present invention is explained in detail and the following Examples and Comparative Examples should not be construed as limiting the scope of the present invention.

Preparing of Raw Paper

A pulp slurry was prepared by beating LBKP (broad-leaf kraft pulp, bleaching pulp) to 300 ml of Canadian Standard Freeness using a disk refiner so that the pulp fiber has a length of 0.58 mm. The prepared pulp slurry was mixed with the additives shown in Table 2 in an amount shown in Table 2, thereby preparing a paper material for producing the raw paper.

TABLE 2

| Type of Additives | Amount (%) |
|---|---|
| Cationic Starch | 1.2 |
| Alkyl Ketene Dimer (AKD) | 0.5 |
| Anionic Polyacrylamide | 0.3 |
| Epoxidized Fatty acid Amide (EFA) | 0.2 |
| Polyamidepolyamineepichlorohydrin | 0.3 |

wherein AKD comprises an alkyl moiety of a fatty acid (mainly behenic acid) derivative, EFA comprises a fatty acid moiety of a fatty acid (mainly behenic acid) derivative, and the amount (%) is relative to 100% of the mass of the pulp.

The prepared paper material was subjected to the paper making using a Fourdrinier paper-making machine to produce a raw paper having a basis weight of 150 g/m². During the drying in the paper making by the Fourdrinier paper-making machine, the both surfaces of the obtained raw paper was coated respectively with a polyvinyl alcohol (PVA) in an amount of 1.0 g/m² and with CaCl₂ in an amount of 0.8 g/m² using a size press apparatus to dry the obtained raw paper and the dried raw paper was subjected to a calendar treatment using a soft calendar apparatus, thereby controlling the density of the raw paper to 1.01 g/cm³. Also, during the drying, a surface of the raw paper on which a toner image-receiving layer will be disposed was pressed to the metal roll having a surface temperature of 140° C. The obtained raw paper had a whiteness degree of 91%, an Oken type smoothness (TAPPI smoothness) of 265 sec and a sizing/Stöckigt method of 127 sec.

The obtained raw paper was subjected to the corona discharge having an output of 17 kW and on the back surface of the obtained raw paper, a polyethylene resin having a composition (70% by mass of HDPE and 30% by mass of LDPE) shown in Table 3 was laminated by single-layer extrusion using a cooling roll having a surface matt roughness of 10 μm at a molten delivered film temperature of 320° C. and a line speed of 250 m/min, thereby disposing a back surface polyethylene layer having a thickness of 22 μm.

TABLE 3

| | MFR(g/10 min) | Density (g/cm³) | Content (% by mass) |
|---|---|---|---|
| HDPE | 12 | 0.967 | 70 |
| LDPE | 3.5 | 0.923 | 30 |

wherein HDPE means a high density polyethylene and LDPE means a low density polyethylene. MFR and Density are properties of HDPE and LDPE and Content is the composition of the above-noted polyethylene resin.

Next, on the surface of the raw paper (on which the toner image-receiving layer will be disposed), a mixture of an LDPE masterbatch pellet having a composition shown in Table 4 and an LDPE masterbatch pellet comprising a 5% by mass ultramarine blue, wherein the mixture has a composition shown in Table 5, was laminated by single-layer extrusion using a cooling roll having a surface matt roughness of 0.7 μm at a line speed of 250 m/min, thereby disposing a surface polyethylene layer having a thickness of 29 μm.

Thereafter, the surface and the back surface of the raw paper were subjected to the corona discharge having an out put of respectively 18 kW and 12 kW and on the surface and the back surface of the raw paper, a gelatin undercoating layer and an antistatic undercoating layer comprising a colloidal alumina, a colloidal silica and a polyvinyl alcohol (PVA) respectively were disposed, thereby obtaining a support.

TABLE 4

| Composition | Content (% by mass) |
|---|---|
| LDPE(ρ = 0.921 g/cm³) | 37.98 |
| Titanium dioxide in form of anatase | 60.00 |
| Zinc stearate | 2.00 |
| Antioxidant | 0.02 |

TABLE 5

| Composition | Content (% by mass) |
|---|---|
| LDPE(ρ = 0.921 g/cm³) | 67.7 |
| Titanium dioxide in form of anatase | 30.0 |
| Zinc stearate | 2.0 |
| Ultramarine blue | 0.3 |

Preparing of Titanium Dioxide Dispersion

The following components were mixed to disperse titanium dioxide using a dispersing machine (manufactured and sold by Nihon Seiki Seisakusho Co., Ltd.; trade name: NBK-2), thereby preparing a titanium dioxide dispersion,
48 Parts by mass of titanium dioxide (manufactured and sold by Ishihara Sangyo Kaisha, Ltd.; trade name: TIPAQUE R780-2),
4 parts by mass of a polyvinyl butyral (manufactured and sold by Kuraray Co., Ltd.; trade name: PVA 205 C),
0.6 parts by mass of a surfactant (manufactured and sold by Kao Corporation; trade name: DEMOL EP), and
31.6 parts by mass of an ion-exchanged water.
   Preparing of Self-Dispersible Hydrophilic Polyester Resin Emulsion

Polyester resins A to D having respectively a composition shown in Table 6 were prepared according to a method described in JP-A No. 2002-173582. Using these polyester resins respectively, a self-dispersible hydrophilic resin emulsion respectively was prepared.

The composition, number average molecular weight (Mn), weight average molecular weight (Mw), molecular-weight distribution (Mw/Mn) and glass transition temperature (Tg) of the obtained polyester resins A to D respectively were measured as follows. The result of the measurement is shown in Table 6.

<Composition of Polyester Resins>

The composition of the polyester resins respectively was determined using an apparatus for ¹H-NMR spectrophotometry (manufactured and sold by Varian, Inc.; measuring frequency of 300 MHz).

<Mn, Mw and Mw/Mn of Polyester Resins>

Number average molecular weight (Mn), weight average molecular weight (Mw) and molecular-weight distribution (Mw/Mn) were measured according to the gel permeation chromatography using a pumping unit (LC-10 AD vp) and ultraviolet-visible spectrophotometer (SPD-6AV)(manufactured and sold by SHIMADZU CORPORATION) under the condition where a detecting wavelength is 254 nm, a solvent is tetrahydrofuran and a measured value is a converted value as polystyrene.

<Tg of Polyester Resins>

10 mg of the sample of each polyester resin was subjected to Differential Scanning Calorimetry (DSC) using an apparatus for DSC (manufactured and sold by Perkin Elmer, Inc.; trade name: DSC 7) under the condition where a temperature elevating rate is 10° C./min, thereby obtaining a DSC curve and using the obtained DSC curve, the glass transition temperature was measured in such a manner that a mean value of two temperatures corresponding to two bending points in the DSC curve which were caused due to the glass transition, was measured as the glass transition temperature.

TABLE 6

| | | | Resin A | Resin B | Resin C | Resin D |
|---|---|---|---|---|---|---|
| Polyester | Acid component | Terephthalic acid | 70 | 100 | 70 | 60 |
| Resin | (in molar ratio) | Isophthalic acid | 30 | — | 30 | 25 |
| Composition | | Adipic acid | — | — | — | 15 |
| | Alcohol component | Ethylene glycol | 55 | 35 | 55 | 30 |
| | (in molar ratio) | Neopentyl glycol | 45 | 35 | 45 | 70 |
| | | B.A.E.O. | — | 30 | — | — |

| | | | | |
|---|---|---|---|---|
| Glass transition temperature (Tg) | 62° C. | 70° C. | 62° C. | 41° C. |
| Number average molecular weight (Mn) | 6000 | 6500 | 3500 | 7000 |
| Molecular-Weight distribution (Mw/Mn) | 2.5 | 3.5 | 2.2 | 2.5 |

wherein “B. A. E. O.” means “Bisphenol A ethylene oxide adduct”.

### EXAMPLE 1

Producing of Image-Receiving Sheet for Electrophotography

By mixing the following components, a coating liquid for producing the toner image-receiving layer was prepared according to a conventional method. A surface of the above-noted laminated paper in which on the both surfaces of the paper, a polyethylene is laminated, was coated with the above-prepared coating liquid in an amount of 10 g/m² in terms of dry weight using a bar coater and the coated laminated paper was dried at 90° C. for 5 minutes, thereby producing the image-receiving sheet for the electrophotography of Example 1.

<Components for Producing Toner Image-Receiving Layer>

200 Parts by mass of a polyester resin aqueous dispersion (resin A in Table 6, having a solid content of 30% by mass)
128.7 Parts by mass of water
15.5 Parts by mass of the above-prepared titanium dioxide dispersion
10 Parts by mass of a carnauba wax aqueous dispersion (manufactured and sold by Chukyo Yushi Co., Ltd.; trade name: Cellosol 524)
4.8 parts by mass of a polyethylene oxide (manufactured and sold by Meisei Chemical Works, Ltd.; trade name: ALKOX R 1000)
1.5 parts by mass of an anionic surfactant (manufactured and sold by NOF Corporation; trade name: Rapisol A 90)

### EXAMPLE 2

Producing of Image-Receiving Sheet for Electrophotography

The image-receiving sheet for the electrophotography of Example 2 was produced in substantially the same manner as in Example 1, except that instead of the above-noted laminated paper in which on the both surfaces of the paper, a polyethylene is laminated, the above-noted raw paper was used as the support.

### COMPARATIVE EXAMPLE 1

Producing of Image-Receiving Sheet for Electrophotography

The image-receiving sheet for the electrophotography of Comparative Example 1 was produced in substantially the same manner as in Example 1, except that instead of the components for producing the toner image-receiving layer used in Example 1, the following components were used.

<Components for Producing Toner Image-Receiving Layer>

200 Parts by mass of a polyester resin aqueous dispersion (resin D in Table 6, having a solid content of 30% by mass)
128.7 Parts by mass of water
15.5 Parts by mass of the above-prepared titanium dioxide dispersion
10 Parts by mass of a carnauba wax aqueous dispersion (manufactured and sold by Chukyo Yushi Co., Ltd.; trade name: Cellosol 524)
4.8 parts by mass of a polyethylene oxide (manufactured and sold by Meisei Chemical Works, Ltd.; trade name: ALKOX R 1000)
1.5 parts by mass of an anionic surfactant (manufactured and sold by NOF Corporation; trade name: Rapisol A 90)

### COMPARATIVE EXAMPLE 2

Producing of Image-Receiving Sheet for Electrophotography

The image-receiving sheet for the electrophotography of Comparative Example 2 was produced in substantially the same manner as in Example 1, except that instead of the components for producing the toner image-receiving layer used in Example 1, the following components were used.

<Components for Producing Toner Image-Receiving Layer>

200 Parts by mass of a polyester resin aqueous dispersion (resin B in Table 6, having a solid content of 30% by mass)
128.7 Parts by mass of water
15.5 Parts by mass of the above-prepared titanium dioxide dispersion
10 Parts by mass of a carnauba wax aqueous dispersion (manufactured and sold by Chukyo Yushi Co., Ltd.; trade name: Cellosol 524)
4.8 parts by mass of a polyethylene oxide (manufactured and sold by Meisei Chemical Works, Ltd.; trade name: ALKOX R 1000)
1.5 parts by mass of an anionic surfactant (manufactured and sold by NOF Corporation; trade name: Rapisol A 90)

### COMPARATIVE EXAMPLE 3

Producing of Image-Receiving Sheet for Electrophotography

The image-receiving sheet for the electrophotography of Comparative Example 3 was produced in substantially the same manner as in Example 1, except that instead of the components for producing the toner image-receiving layer used in Example 1, the following components were used.

<Components for Producing Toner Image-Receiving Layer>

200 Parts by mass of a polyester resin aqueous dispersion (resin C in Table 6, having a solid content of 30% by mass)
128.7 Parts by mass of water
15.5 Parts by mass of the above-prepared titanium dioxide dispersion
10 Parts by mass of a carnauba wax aqueous dispersion (manufactured and sold by Chukyo Yushi Co., Ltd.; trade name: Cellosol 524)
4.8 parts by mass of a polyethylene oxide (manufactured and sold by Meisei Chemical Works, Ltd.; trade name: ALKOX R 1000)
1.5 parts by mass of an anionic surfactant (manufactured and sold by NOF Corporation; trade name: Rapisol A 90)

### COMPARATIVE EXAMPLE 4

Producing of Image-Receiving Sheet for Electrophotography

The image-receiving sheet for the electrophotography of Comparative Example 4 was produced in substantially the same manner as in Comparative Example 2, except that instead of the above-noted laminated paper in which on the both surfaces of the paper, a polyethylene is laminated, the above-noted raw paper was used as the support.

Next, with respect to the obtained toner image-receiving sheets for the electrophtography of Examples 1 to 2 and Comparative Examples 1 to 4 respectively, glossiness, relief and adhesion resistance were respectively evaluated according to the following method.

<Evaluation of Glossiness>

Using a color laser printer (manufactured and sold by Fuji Xerox Co., Ltd.;
trade name: DocuPrint C-620), four images, such as an image of white, an image of gray (all of R value, G value and B value of the image are 50%), an image of black and an image of a woman's portrait were printed (formed) on the samples of each produced toner image-receiving sheet for the electrophtography in Examples 1 to 2 and Comparative Examples 1 to 4 and the glossiness of the samples which were put on a table in the room, was evaluated visually according to the following evaluation criteria. With respect to a sample (e.g., a sample of the toner image-receiving sheet produced in Example 1), a glossiness of a print having the lowest glossiness among the above-noted four images (e.g., a glossiness of an image of black with respect to the sample of the sheet of Example 1) is the evaluation result of the sample (e.g., the evaluation result of the sample of the toner image-receiving sheet produced in Example 1 will be a glossiness of an image of black printed on the toner image-receiving sheet produced in Example 1).
   [Evaluation Criteria]
A: the image is rich in the glossiness and a fluorescent light (irradiated from a fluorescent lamp set on the ceiling) on the image can satisfactorily confirmed.
B: the image is relatively poor in the glossiness and the fluorescent light on the image can dimly confirmed.
C: the image is markedly poor in the glossiness.
   <Evaluation of Relief>

Using a color laser printer (manufactured and sold by Fuji Xerox Co., Ltd.; trade name: DocuPrint C-620), an image of a square having a size of 1 cm×1 cm which is full in black color was printed on the samples of each produced toner image-receiving sheet for the electrophtography in Examples 1 to 2 and Comparative Examples 1 to 4 and the relief of the printed image was evaluated by evaluating the height-unevenness degree of a fluorescent light (irradiated from a fluorescent lamp set on the ceiling) image reflected on the above-noted black image according to the following evaluation criteria.

[Evaluation Criteria]

A: the fluorescent light image has substantially no height-unevenness.
B: the fluorescent light image has a slight height-unevenness.
C: the fluorescent light image has a sharp height-unevenness.
   Evaluation of Adhesion Resistance

The sample for evaluation of the adhesion resistance was prepared with respect to each produced toner image-receiving sheet for the electrophtography in Examples 1 to 2 and Comparative Examples 1 to 4 in such a manner that two toner image-receiving sheets having a size of A4 are superimposed by contacting the toner image-receiving layer of a sheet with that of another sheet, thereby obtaining the sample comprising two sheets. The obtained sample was subject to the pressing by a weight of 500 g which has a size of 3.5 cm×3.5 cm and left under the pressing in a dry atmosphere (at 50° C.) for 3 days and in a wet atmosphere (at 40° C. in 80% RH) for 3 days. With respect to the resultant sample, the adhesion resistance of the sheet was evaluated by observation of peeling a sheet from another sheet in the sample according to the following criteria. According to the present invention, the adhesion resistances represented by the following criteria A and B are practically qualified.

[Evaluation Criteria]

A there was no peeling sound and no adhesion trace.
B there was a light peeling sound and a light adhesion trace.
C there was remained less than 25% of an adhesion trace.
D there was remained 25% to 50% of an adhesion trace.

E there was remained 50% or more of an adhesion trace.

TABLE 7

| | | Properties of Polyester Resin | | | | | Adhesion Resistance | |
|---|---|---|---|---|---|---|---|---|
| | Support | Tg | Mn | Mw/Mn | Glossiness | Relief | Dry | Wet |
| Ex. 1 | PE Paper | 62° C. | 6000 | 2.5 | B | B | B | B |
| Ex. 2 | Raw Paper | 62° C. | 6000 | 2.5 | C | B | B | B |
| Comp. | PE Paper | 41° C. | 7000 | 2.5 | B | B | E | E |
| Ex. 1 | | | | | | | | |
| Comp. | PE Paper | 70° C. | 6500 | 3.5 | C | E | B | B |
| Ex. 2 | | | | | | | | |
| Comp. | PE Paper | 62° C. | 3500 | 2.2 | B | B | E | E |
| Ex. 3 | | | | | | | | |
| Comp. | Raw Paper | 70° C. | 6500 | 3.5 | E | E | B | B |
| Ex. 4 | | | | | | | | |

From the result shown in Table 7, it is confirmed that the toner image-receiving sheet for the electrophotography produced in Examples 1 and 2 which comprises in the toner image-receiving layer a polyester resin having a glass transition temperature (Tg) of higher than 60° C., a number average molecular weight (Mn) of 5,000 to 12,000 and the ratio (Mw/Mn) between the weight average molecular weight (Mw) and the number average molecular weight (Mn) of 1≦Mw/Mn≦3 are more excellent in glossiness, relief and adhesion resistance than the toner image-receiving sheet for the electrophotography produced in Comparative Examples 1 to 4.

### INDUSTRIAL APPLICABILITY

The image-receiving sheet for the electrophotography according to the present invention can form an image having excellent glossiness and a little concave and convex (relief), is excellent in adhesion resistance and shelf stability, and can mitigate an environmental load during the production thereof, so that it can be widely used in various image-forming apparatus.

1. An image-receiving sheet for the electrophotography comprising:
a support, and
a toner image-receiving layer disposed on the support,
wherein the toner image-receiving layer comprises a thermoplastic resin which is a polyester resin having a glass transition temperature (Tg) of higher than 60° C., a number average molecular weight (Mn) of 5,000 to 12,000 and the ratio (Mw/Mn) between the weight average molecular weight (Mw) and the number average molecular weight (Mn) of 1≦Mw/Mn≦3.

2. The image-receiving sheet for the electrophotography according to claim 1,
wherein the polyester resin has a glass transition temperature (Tg) of 61° C. to 100° C., a number average molecular weight (Mn) of 5,000 to 10,000 and the ratio (Mw/Mn) between the weight average molecular weight (Mw) and the number average molecular weight (Mn) of 1.2≦Mw/Mn≦2.5.

3. The image-receiving sheet for the electrophotography according to claim 1,
wherein the polyester resin is a self-dispersible hydrophilic polyester resin emulsion.

4. The image-receiving sheet for the electrophotography according to claim 3,
wherein the self-dispersible hydrophilic polyester resin emulsion is a self-dispersible hydrophilic polyester resin emulsion of a carboxyl group type which has a carboxy group as a hydrophilic group.

5. The image-receiving sheet for the electrophotography according to claim 1,
wherein the support is one selected from the group consisting of raw paper, a synthetic paper, a synthetic resin sheet, a coated paper and a laminated paper.

6. The image-receiving sheet for the electrophotography according to claim 5,
wherein the support comprises the raw paper and polyolefin resin layers disposed on the both surfaces of the raw paper.

7. The image-receiving sheet for the electrophotography according to claim 6,
wherein the polyolefin resin layer comprises a polyethylene.

8. An image-forming process comprising:
forming a toner image in an image-receiving sheet for the electrophotography, and
fixing the toner image formed in the forming of the toner image by smoothing the surface of the toner image,
wherein the image-receiving sheet for the electrophotography comprises:
a support, and
a toner image-receiving layer disposed on the support,
wherein the toner image-receiving layer comprises a thermoplastic resin which is a polyester resin having a glass transition temperature (Tg) of higher than 60° C., a number average molecular weight (Mn) of 5,000 to 12,000 and the ratio (Mw/Mn) between the weight average molecular weight (Mw) and the number average molecular weight (Mn) of 1≦Mw/Mn≦3.

9. The image-forming process according to claim 8,
wherein the polyester resin has a glass transition temperature (Tg) of 61° C. to 100° C., a number average molecular weight (Mn) of 5,000 to 10,000 and the ratio (Mw/Mn) between the weight average molecular weight (Mw) and the number average molecular weight (Mn) of 1.2≦Mw/Mn≦2.5.

10. The image-forming process according to claim 9,
wherein the fixing of the toner image by smoothing the surface of the toner image is performed by heating, pressing and cooling the toner image and by peeling the image-receiving sheet from the belt using an apparatus configured to fix the toner image by smoothing the surface of the toner image which is equipped with a heating-pressing unit, a belt and a cooling unit.

11. The image-forming process according to claim 9,
wherein on the surface of the belt, a fluorocarbon siloxane rubber layer is disposed.

12. The image-forming process according to claim 11,
wherein a fluorocarbon siloxane rubber in the fluorocarbon siloxane rubber layer has in the backbone chain thereof at least one of a perfluoroalkyl ether group and a perfluoroalkyl group.

13. The image-forming process according to claim 9,
wherein on the surface of the belt, a silicone rubber layer is disposed and on the surface of the silicone rubber layer, a fluorocarbon siloxane rubber layer is disposed.

14. The image-forming process according to claim 13,
wherein a fluorocarbon siloxane rubber in the fluorocarbon siloxane rubber layer has in the backbone chain thereof at least one of a perfluoroalkyl ether group and a perfluoroalkyl group.
